(19) United States
(12) Patent Application Publication
(10) Pub. No.: US 2021/0295059 A1
(43) Pub. Date: Sep. 23, 2021

(54) STRUCTURED TEXTURE EMBEDDINGS IN PATHWAY ARTICLES FOR MACHINE RECOGNITION

(71) Applicant: 3M INNOVATIVE PROPERTIES COMPANY, St. Paul, MN (US)

(72) Inventors: Panagiotis Stanitsas, Foster City, CA (US); James W. Howard, North Oaks, MN (US); Andrew W. Long, Woodbury, MN (US); James B. Snyder, Minneapolis, MN (US); Ravi R. Srinivas, St. Paul, MN (US); Payas Tikotekar, Woodbury, MN (US)

(21) Appl. No.: 17/267,359

(22) PCT Filed: Aug. 16, 2019
(86) PCT No.: PCT/US2019/046856

§ 371 Date: Feb. 9, 2021

Related U.S. Application Data
(60) Provisional application No. 62/719,269, filed on Aug. 17, 2018.

(51) Int. Cl. G06K 9/00; G06K 9/20; G06K 9/62

(52) U.S. Cl. CPC G06K 9/00791; G06K 9/6256; G06K 9/2036

(57) ABSTRACT

In some examples, an article of conspicuity tape includes a retroreflective substrate; and a structured texture element (STE) embodied on the retroreflective substrate, wherein a visual appearance of the structured texture element is computationally generated for differentiation from a visual appearance of a natural environment scene for the article of conspicuity tape.

### TECHNICAL FIELD

The present application relates generally to pathway articles and systems in which such pathway articles may be used.

### BACKGROUND

Current and next generation vehicles may include those with a fully automated guidance systems, semi-automated guidance and fully manual vehicles. Semi-automated vehicles may include those with advanced driver assistance systems (ADAS) that may be designed to assist drivers avoid accidents. Automated and semi-automated vehicles may include adaptive features that may automate lighting, provide adaptive cruise control, automate braking, incorporate GPS/traffic warnings, connect to smartphones, alert driver to other cars or dangers, keep the driver in the correct lane, show what is in blind spots and other features. Infrastructure may increasingly become more intelligent by including systems to help vehicles move more safely and efficiently such as installing sensors, communication devices and other systems. Over the next several decades, vehicles of all types, manual, semi-automated and automated, may operate on the same roads and may need operate cooperatively and synchronously for safety and efficiency.

### SUMMARY

In general, this disclosure is directed to structured texture embeddings (STEs) in retroreflective articles for machine recognition. Retroreflective articles may be used in various vehicle and pathway applications, such as conspicuity tape that is applied to vehicles and pavement markings that are embodied on vehicle pathways. As an example, conspicuity tape may be applied to vehicles in order to enhance the visibility of the vehicle for other drivers, vehicles, and pedestrians. Conventionally, conspicuity tape may include a solid color or alternating stripe pattern to improve visibility of the conspicuity tape for humans. As vehicles with fully- and semi-automated guidance systems become more prevalent on pathways, these guidance systems may rely on various sensing modalities including machine vision to recognize objects and react accordingly. Machine vision systems may use feature recognition techniques, such as Scale-Invariant Feature Transform (SIFT) and Speeded Up Robust Features (SURF), to identify objects and/or object features in a scene for vehicle navigation and vehicle control, among other operations. Feature recognition techniques may identify features in a scene, which are then used to identify and/or classify objects based on the identified features.

Because vehicles may operate in natural environments with many features in a single scene (e.g., an image of a natural environment in which a vehicle operates at a particular point in time), feature recognition techniques may, at times, have difficulty identifying and/or classifying objects that are not sufficiently differentiated from other objects in a scene. In other words, in increasingly complex scenes, it may be more difficult for feature recognition techniques to identify and/or classify objects with sufficient confidence to make vehicle navigation and vehicle control decisions. Articles and techniques of this disclosure may include STEs in articles, such as conspicuity tape and pavement markings, that improve the identification and classification of objects when using feature recognition techniques. Rather than using a human constructed design (such as solid color or pattern for improved human visibility), which may not be easily differentiated from other object in a natural environment, techniques of this disclosure may generate STEs that are computationally generated for differentiation from features or objects in natural environments in which the article that includes the STE is used. For instance, STEs in this disclosure may be computationally generated patterns or other arrangements of visual indicia that are specifically and intentionally generated for an optimized or maximum differentiation from other features or objects in natural environments in which the article that includes the STE is used. By computationally increasing the amount of dissimilarity between the visual appearance of a particular STE from a natural environment scene (and/or other STEs), feature recognition techniques, such as Scale-Invariant Feature Transform (SIFT) and Speeded Up Robust Features (SURF), may identify and/or classify the object that includes the STE. In this way, improving the confidence levels of identification and/or classification of objects may improve vehicle navigation and vehicle control decisions, among other possible operations. Improving vehicle navigation and vehicle control decisions may improve vehicle and/or pedestrian safety, fuel consumption, and rider comfort.

In some examples, fully- and semi-automated guidance systems may determine information that corresponds to an arrangement of features in the STE and perform operations based at least in part on the information that corresponds to the arrangement of features in the STE. For example, information that corresponds to an arrangement of features in the STE may indicate that an object attached to the STE is part of an autonomous vehicle platoon. As an example, an STE indicating an autonomous vehicle platoon may be included in conspicuity tape that is applied to a shipping trailer in the autonomous vehicle platoon. When a fully- or semi-automated guidance system of a particular vehicle identifies and classifies the STE, including the information indicating the autonomous vehicle platoon, the particular vehicle may perform driving decisions to pass or otherwise overtake the autonomous vehicle platoon with higher confidence because information indicating the type of object that the particular vehicle is passing or overtaking is available to the guidance system. In other examples, a type of object or physical dimensions (e.g., length, width, depth) of an object may be included as information in or associated with the arrangement of features in the STE. In this way, fully- and semi-automated guidance systems may rely on STEs to improve the confidence levels of identification and/or classification of objects in a natural scene, but also use additional information from the STE to make vehicle navigation and vehicle control decisions.

In some examples, system includes a light capture device; a computing device communicatively coupled to the light capture device, wherein the computing device is configured to: receive, from the light capture device, retroreflected light that indicates a structured texture element (STE) embodied on a retroreflective article, wherein a visual appearance of the structured texture element is computationally generated for differentiation from a visual appearance of a natural environment scene for the article of conspicuity tape; determine information that corresponds to an arrangement of features in the STE; and perform at least one operation based at least in part on the information that corresponds to the arrangement of features in the STE.

In some examples, article comprises: a retroreflective substrate; and a structured texture element (STE) embodied on the retroreflective substrate, wherein a visual appearance of the structured texture element is computationally generated for differentiation from a visual appearance of a natural environment scene for the article of conspicuity tape.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system with an enhanced sign that is configured to be interpreted by a PAAV, in accordance with this disclosure.

FIG. 2 is a block diagram illustrating an example computing device, in accordance with this disclosure.

FIG. 3 is a conceptual diagram of a cross-sectional view of a pathway article, in accordance with this disclosure.

FIGS. 4A and 4B illustrate cross-sectional views of portions of an article message formed on a retroreflective sheet, in accordance with this disclosure.

FIG. 5 is a block diagram illustrating an example computing device, in accordance with one or more aspects of the present disclosure.

FIG. 6 illustrates structured texture embeddings that may be implemented at retroreflective articles, in accordance with this disclosure.

FIGS. 7A and 7B, illustrate candidate patterns in the visible spectrum as shown in FIG. 7A and the IR spectrum in FIG. 7B, in accordance with this disclosure.

FIG. 8 illustrates computationally generating STEs for differentiation, in accordance with this disclosure.

FIGS. 9A-9B present sample outputs of validation performed by a computing device, in accordance with this disclosure.

FIG. 10 is a block diagram illustrating different patterns that may be embodied on an article with an STE, in accordance with this disclosure.

### DETAILED DESCRIPTION

Even with advances in autonomous driving technology, infrastructure, including vehicle roadways, may have a long transition period during which fully PAAVs, vehicles with advanced Automated Driver Assist Systems (ADAS), and traditional fully human operated vehicles share the road. Some practical constraints may make this transition period decades long, such as the service life of vehicles currently on the road, the capital invested in current infrastructure and the cost of replacement, and the time to manufacture, distribute, and install fully autonomous vehicles and infrastructure.

Autonomous vehicles and ADAS, which may be referred to as semi-autonomous vehicles, may use various sensors to perceive the environment, infrastructure, and other objects around the vehicle. These various sensors combined with onboard computer processing may allow the automated system to perceive complex information and respond to it more quickly than a human driver. In this disclosure, a vehicle may include any vehicle with or without sensors, such as a vision system, to interpret a vehicle pathway. A vehicle with vision systems or other sensors that takes cues from the vehicle pathway may be called a pathway-article assisted vehicle (PAAV). Some examples of PAAVs may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. A vehicle pathway may be a road, highway, a warehouse aisle, factory floor or a pathway not connected to the earth's surface. The vehicle pathway may include portions not limited to the pathway itself. In the example of a road, the pathway may include the road shoulder, physical structures near the pathway such as toll booths, railroad crossing equipment, traffic lights, the sides of a mountain, guardrails, and generally encompassing any other properties or characteristics of the pathway or objects/structures in proximity to the pathway. This will be described in more detail below.

In general, a pathway article may be any article or object embodied, attached, used, or placed at or near a pathway. For instance, a pathway article may be embodied, attached, used, or placed at or near a vehicle, pedestrian, micromobility device (e.g., scooter, food-delivery device, drone, etc.), pathway surface, intersection, building, or other area or object of a pathway. Examples of pathway articles include, but are not limited to signs, pavement markings, temporary traffic articles (e.g., cones, barrels), conspicuity tape, vehicle components, human apparel, stickers, or any other object embodied, attached, used, or placed at or near a pathway.

A pathway article, such as a sign, may include an article message on the physical surface of the pathway article. In this disclosure, an article message may include images, graphics, characters, such as numbers or letters or any combination of characters, symbols or non-characters. An article message may include or be an STE. An article message may include human-perceptible information and machine-perceptible information. Human-perceptible information may include information that indicates one or more first characteristics of a vehicle pathway primary information, such as information typically intended to be interpreted by human drivers. In other words, the human-perceptible information may provide a human-perceptible representation that is descriptive of at least a portion of the vehicle pathway. As described herein, human-perceptible information may generally refer to information that indicates a general characteristic of a vehicle pathway and that is intended to be interpreted by a human driver. For example, the human-perceptible information may include words (e.g., “dead end” or the like), symbols or graphics (e.g., an arrow indicating the road ahead includes a sharp turn). Human-perceptible information may include the color of the article message or other features of the pathway article, such as the border or background color. For example, some background colors may indicate information only, such as “scenic overlook” while other colors may indicate a potential hazard.

In some instances, the human-perceptible information may correspond to words or graphics included in a specification. For example, in the United States (U.S.), the human-perceptible information may correspond to words or symbols included in the Manual on Uniform Traffic Control Devices (MUTCD), which is published by the U.S. Department of Transportation (DOT) and includes specifications for many conventional signs for roadways. Other countries have similar specifications for traffic control symbols and devices. In some examples, the human-perceptible information may be referred to as primary information.

In some examples, the pathway article also include second, additional information that may be interpreted by a PAAV. As described herein, second information or machine-perceptible information may generally refer to additional detailed characteristics of the vehicle pathway or associated objects. The machine-perceptible information is configured to be interpreted by a PAAV, but in some examples, may be interpreted by a human driver. In other words, machine-perceptible information may include a feature of the graphical symbol that is a computer-interpretable visual property of the graphical symbol. In some examples, the machine-perceptible information may relate to the human-perceptible information, e.g., provide additional context for the human-perceptible information. In an example of an arrow indicating a sharp turn, the human-perceptible information may be a general representation of an arrow, while the machine-perceptible information may provide an indication of the particular shape of the turn including the turn radius, any incline of the roadway, a distance from the sign to the turn, or the like. The additional information may be visible to a human operator; however, the additional information may not be readily interpretable by the human operator, particularly at speed. In other examples, the additional information may not be visible to a human operator, but may still be machine readable and visible to a vision system of a PAAV. In some examples, an enhanced sign may be considered an optically active article.

In some examples, pathway articles of this disclosure may include redundant sources of information to verify inputs and ensure the vehicles make the appropriate response. The techniques of this disclosure may provide pathway articles with an advantage for intelligent infrastructures, because such articles may provide information that can be interpreted by both machines and humans. This may allow verification that both autonomous systems and human drivers are receiving the same message.

Redundancy and security may be of concern for a partially and fully autonomous vehicle infrastructure. A blank highway approach to an autonomous infrastructure, i.e. one in which there is no signage or markings on the road and all vehicles are controlled by information from the cloud, may be susceptible to hackers, terroristic ill intent, and unintentional human error. For example, GPS signals can be spoofed to interfere with drone and aircraft navigation. The techniques of this disclosure provide local, onboard redundant validation of information received from GPS and the cloud. The pathway articles of this disclosure may provide additional information to autonomous systems in a manner which is at least partially perceptible by human drivers. Therefore, the techniques of this disclosure may provide solutions that may support the long-term transition to a fully autonomous infrastructure because it can be implemented in high impact areas first and expanded to other areas as budgets and technology allow.

Hence, pathway articles of this disclosure may provide additional information that may be processed by the onboard computing systems of the vehicle, along with information from the other sensors on the vehicle that are interpreting the vehicle pathway. The pathway articles of this disclosure may also have advantages in applications such as for vehicles operating in warehouses, factories, airports, airways, waterways, underground or pit mines and similar locations.

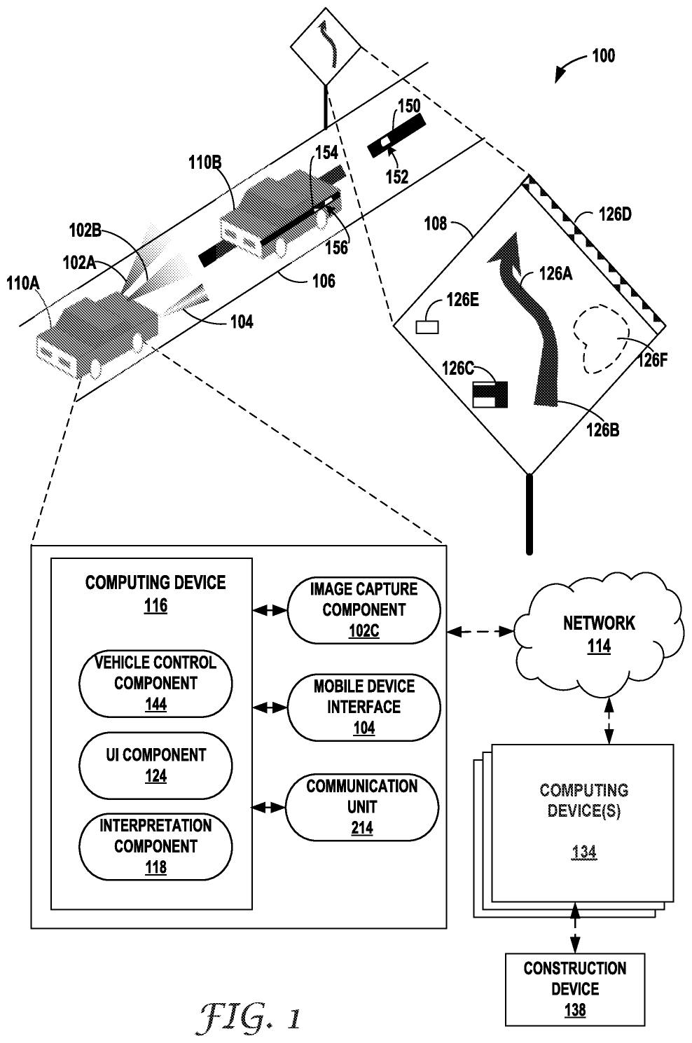

FIG. 1 is a block diagram illustrating an example system 100 with conspicuity tape 154 that may include one or more STEs 156 configured to be interpreted by a PAAV in accordance with techniques of this disclosure. As described herein, PAAV generally refers to a vehicle with a vision system, along with other sensors, that may interpret the vehicle pathway and the vehicle's environment, such as other vehicles or objects. A PAAV may interpret information from the vision system and other sensors, make decisions and take actions to navigate the vehicle pathway.

As shown in FIG. 1, system 100 includes PAAV 110A that may operate on vehicle pathway 106 and that includes image capture devices 102A and 102B and computing device 116. Any number of image capture devices may be possible and may positioned or oriented in any direction from the vehicle including rearward, forward and to the sides of the vehicle. The illustrated example of system 100 also includes one or more pathway articles as described in this disclosure, such as conspicuity tape 154 that may include one or more STEs 156.

As noted above, PAAV 110A of system 100 may be an autonomous or semi-autonomous vehicle, such as an ADAS. In some examples PAAV 110A may include occupants that may take full or partial control of PAAV 110A. PAAV 110A may be any type of vehicle designed to carry passengers or freight including small electric powered vehicles, large trucks or lorries with trailers, vehicles designed to carry crushed ore within an underground mine, or similar types of vehicles. PAAV 110A may include lighting, such as headlights in the visible light spectrum as well as light sources in other spectrums, such as infrared. PAAV 110A may include other sensors such as radar, sonar, lidar, GPS and communication links for the purpose of sensing the vehicle pathway, other vehicles in the vicinity, environmental conditions around the vehicle and communicating with infrastructure. For example, a rain sensor may operate the vehicles windshield wipers automatically in response to the amount of precipitation, and may also provide inputs to the onboard computing device 116.

As shown in FIG. 1, PAAV 110A of system 100 may include image capture devices 102A and 102B, collectively referred to as image capture devices 102. Image capture devices 102 may convert light or electromagnetic radiation sensed by one or more image capture sensors into information, such as digital image or bitmap comprising a set of pixels. Other devices, such as LiDAR, may be similarly used for articles and techniques of this disclosure. In the example of FIG. 1, each pixel may have chrominance and/or luminance components that represent the intensity and/or color of light or electromagnetic radiation. In general, image capture devices 102 may be used to gather information about a pathway. Image capture devices 102 may send image capture information to computing device 116 via image capture component 102C. Image capture devices 102 may capture lane markings, centerline markings, edge of roadway or shoulder markings, other vehicles, pedestrians, or objects at or near pathway 106, as well as the general shape of the vehicle pathway. The general shape of a vehicle pathway may include turns, curves, incline, decline, widening, narrowing or other characteristics. Image capture devices 102 may have a fixed field of view or may have an adjustable field of view. An image capture device with an adjustable field of view may be configured to pan left and right, up and down relative to PAAV 110A as well as be able to widen or narrow focus. In some examples, image capture devices 102 may include a first lens and a second lens and/or first and second light sources, such that images may be captured using different light wavelength spectrums.

Image capture devices 102 may include one or more image capture sensors and one or more light sources. In some examples, image capture devices 102 may include image capture sensors and light sources in a single integrated device. In other examples, image capture sensors or light sources may be separate from or otherwise not integrated in image capture devices 102. As described above, PAAV 110A may include light sources separate from image capture devices 102. Examples of image capture sensors within image capture devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, image capture devices 102 includes at least two different sensors for detecting light in two different wavelength spectrums.

In some examples, one or more light sources 104 include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. As shown in FIG. 1 one or more light sources 104 may emit radiation in the near infrared spectrum.

In some examples, image capture devices 102 captures frames at 50 frames per second (fps). Other examples of frame capture rates include 60, 30 and 25 fps. It should be apparent to a skilled artisan that frame capture rates are dependent on application and different rates may be used, such as, for example, 100 or 200 fps. Factors that affect required frame rate are, for example, size of the field of view (e.g., lower frame rates can be used for larger fields of view, but may limit depth of focus), and vehicle speed (higher speed may require a higher frame rate).

In some examples, image capture devices 102 may include at least more than one channel. The channels may be optical channels. The two optical channels may pass through one lens onto a single sensor. In some examples, image capture devices 102 includes at least one sensor, one lens and one band pass filter per channel. The band pass filter permits the transmission of multiple near infrared wavelengths to be received by the single sensor. The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, an enhanced sign of this disclosure, while suppressing other features (e.g., other objects, sunlight, headlights); (c) wavelength region (e.g., broadband light in the visible spectrum and used with either color or monochrome sensors); (d) sensor type or characteristics; (e) time exposure; and (f) optical components (e.g., lensing).

In some examples, image capture devices 102A and 102B may include an adjustable focus function. For example, image capture device 102B may have a wide field of focus that captures images along the length of vehicle pathway 106, as shown in the example of FIG. 1. Computing device 116 may control image capture device 102A to shift to one side or the other of vehicle pathway 106 and narrow focus to capture the image of enhanced sign 108, or other features along vehicle pathway 106. The adjustable focus may be physical, such as adjusting a lens focus, or may be digital, similar to the facial focus function found on desktop conferencing cameras. In the example of FIG. 1, image capture devices 102 may be communicatively coupled to computing device 116 via image capture component 102C. Image capture component 102C may receive image information from the plurality of image capture devices, such as image capture devices 102, perform image processing, such as filtering, amplification and the like, and send image information to computing device 116.

Other components of PAAV 110A that may communicate with computing device 116 may include image capture component 102C, described above, mobile device interface 104, and communication unit 214. In some examples image capture component 102C, mobile device interface 104, and communication unit 214 may be separate from computing device 116 and in other examples may be a component of computing device 116.

Mobile device interface 104 may include a wired or wireless connection to a smartphone, tablet computer, laptop computer or similar device. In some examples, computing device 116 may communicate via mobile device interface 104 for a variety of purposes such as receiving traffic information, address of a desired destination or other purposes. In some examples computing device 116 may communicate to external networks 114, e.g. the cloud, via mobile device interface 104. In other examples, computing device 116 may communicate via communication units 214.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as networks 114. In some examples communication units 214 may transmit and receive messages and information to other vehicles, such as information interpreted from enhanced sign 108. In some examples, communication units 214 may transmit and/or receive satellite signals on a satellite network such as a Global Positioning System (GPS) network.

In the example of FIG. 1, computing device 116 includes vehicle control component 144 and user interface (UI) component 124 and an interpretation component 118. Components 118, 144, and 124 may perform operations described herein using software, hardware, firmware, or a mixture of both hardware, software, and firmware residing in and executing on computing device 116 and/or at one or more other remote computing devices. In some examples, components 118, 144 and 124 may be implemented as hardware, software, and/or a combination of hardware and software.

Computing device 116 may execute components 118, 124, 144 with one or more processors. Computing device 116 may execute any of components 118, 124, 144 as or within a virtual machine executing on underlying hardware. Components 118, 124, 144 may be implemented in various ways. For example, any of components 118, 124, 144 may be implemented as a downloadable or pre-installed application or “app.” In another example, any of components 118, 124, 144 may be implemented as part of an operating system of computing device 116. Computing device 116 may include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of PAAV 110A. In some examples, UI component 124 includes outputs to a user such as displays, such as a display screen, indicator or other lights, audio devices to generate notifications or other audible functions. UI component 24 may also include inputs such as knobs, switches, keyboards, touch screens or similar types of input devices.

Vehicle control component 144 may include for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed as a result of these changes. In some examples, the computing device initiates the determined adjustment for one or more functions of the PAAV based on the machine-perceptible information in conjunction with a human operator that alters one or more functions of the PAAV based on the human-perceptible information.

Interpretation component 118 may receive infrastructure information about vehicle pathway 106 and determine one or more characteristics of vehicle pathway 106, including not only pathway 106 but also objects at or near pathway 106, such as but not limited to other vehicles, pedestrians, or objects. For example, interpretation component 118 may receive images from image capture devices 102 and/or other information from systems of PAAV 110A in order to make determinations about characteristics of vehicle pathway 106. For purposes of this disclosure, references to determinations about vehicle pathway 106 may include determinations about vehicle pathway 106 and/or objects at or near pathway 106, such as but not limited to other vehicles, pedestrians, or objects. As described below, in some examples, interpretation component 118 may transmit such determinations to vehicle control component 144, which may control PAAV 110A based on the information received from interpretation component. In other examples, computing device 116 may use information from interpretation component 118 to generate notifications for a user of PAAV 110A, e.g., notifications that indicate a characteristic or condition of vehicle pathway 106.

Enhanced sign 108 and conspicuity tape 154 represent only a few examples of pathway articles and may include reflective, non-reflective, and/or retroreflective sheet applied to a base surface. An article message, such as but not limited to characters, images, and/or any other information or visual indicia, may be printed, formed, or otherwise embodied on the enhanced sign 108 and/or and conspicuity tape 154. The reflective, non-reflective, and/or retroreflective sheet may be applied to a base surface using one or more techniques and/or materials including but not limited to: mechanical bonding, thermal bonding, chemical bonding, or any other suitable technique for attaching retroreflective sheet to a base surface. A base surface may include any surface of an object (such as described above, e.g., an aluminum plate) to which the reflective, non-reflective, and/or retroreflective sheet may be attached. An article message may be printed, formed, or otherwise embodied on the sheeting using any one or more of an ink, a dye, a thermal transfer ribbon, a colorant, a pigment, and/or an adhesive coated film. In some examples, content is formed from or includes a multi-layer optical film, a material including an optically active pigment or dye, or an optically active pigment or dye.

Enhanced sign 108 in FIG. 1 includes article message 126A-126F (collectively “article message 126”). Article message 126 may include a plurality of components or features that provide information on one or more characteristics of a vehicle pathway. Article message 126 may include primary information (interchangeably referred to herein as human-perceptible information) that indicates general information about vehicle pathway 106. Article message 126 may include additional information (interchangeably referred to herein as machine-perceptible information) that may be configured to be interpreted by a PAAV. Similar article messages may be included on conspicuity tape 154 or other pathway articles.

In the example of FIG. 1, one component of article message 126 includes arrow 126A, a graphical symbol. The general contour of arrow 126A may represent primary information that describes a characteristic of vehicle pathway 106, such as an impending curve. For example, features arrow 126A may include the general contour of arrow 126A and may be interpreted by both a human operator of PAAV 110A as well as computing device 116 onboard PAAV 110A.

In some examples article message 126 may include a machine readable fiducial marker 126C. The fiducial marker may also be referred to as a fiducial tag. Fiducial tag 126C may represent additional information about characteristics of pathway 106, such as the radius of the impending curve indicated by arrow 126A or a scale factor for the shape of arrow 126A. In some examples, fiducial tag 126C may indicate to computing device 116 that enhanced sign 108 is an enhanced sign rather than a conventional sign. In other examples, fiducial tag 126C may act as a security element that indicates enhanced sign 108 is not a counterfeit. Similar article machine readable fiducial markers may be included on conspicuity tape 154 or other pathway articles.

In other examples, other portions of article message 126 may indicate to computing device 116 that a pathway article is an enhanced sign. For example, according to aspects of this disclosure, article message 126 may include a change in polarization in area 126F. In this example, computing device 116 may identify the change in polarization and determine that article message 126 includes additional information regarding vehicle pathway 106. Similar portions may be included on conspicuity tape 154 or other pathway articles.

In accordance with techniques of this disclosure, enhanced sign 108 further includes article message components such as one or more security elements 126E, separate from fiducial tag 126C. In some examples, security elements 126E may be any portion of article message 126 that is printed, formed, or otherwise embodied on enhanced sign 108 that facilitates the detection of counterfeit pathway articles. Similar security elements may be included on conspicuity tape 154 or other pathway articles.

Enhanced sign 108 may also include the additional information that represent characteristics of vehicle pathway 106 that may be printed, or otherwise disposed in locations that do not interfere with the graphical symbols, such as arrow 126A. For example, border information 126D may include additional information such as number of curves to the left and right, the radius of each curve and the distance between each curve. The example of FIG. 1 depicts border information 126D as along a top border of enhanced sign 108. In other examples, border information 126D may be placed along a partial border, or along two or more borders. Similar border information may be included on conspicuity tape 154 or other pathway articles.

Similarly, enhanced sign 108 may include components of article message 126 that do not interfere with the graphical symbols by placing the additional machine readable information so it is detectable outside the visible light spectrum, such as area 126F. As described above in relation to fiducial tag 126C, thickened portion 126B, border information 126D, area 126F may include detailed information about additional characteristics of vehicle pathway 106 or any other information. Similar information may be included on conspicuity tape 154 or other pathway articles.

As described above for area 126F, some components of article message 126 may only be detectable outside the visible light spectrum. This may have advantages of avoiding interfering with a human operator interpreting enhanced sign 108, providing additional security. The non-visible components of article message 126 may include area 126F, security elements 126E and fiducial tag 126C.

Non-visible components in FIG. 1 are described for illustration purposes as being formed by different areas that either retroreflect or do not retroreflect light, non-visible components in FIG. 1 may be printed, formed, or otherwise embodied in a pathway article using any light reflecting technique in which information may be determined from non-visible components. For instance, non-visible components may be printed using visibly-opaque, infrared-transparent ink and/or visibly-opaque, infrared-opaque ink. In some examples, non-visible components may be placed on enhanced sign 108, conspicuity tape 154, or other pathway articles by employing polarization techniques, such as right circular polarization, left circular polarization or similar techniques.

According to aspects of this disclosure, in operation, interpretation component 118 may receive an image of enhanced sign 108 and/or conspicuity tape 154 via image capture component 102C and interpret information the image. For example, interpretation component 118 may interpret fiducial tag 126C and determine that (a) enhanced sign 108 contains additional, machine readable information and (b) that enhanced sign 108 is not counterfeit. Interpretation component 118 may identify and/or classify STE 156 in conspicuity tape 154. As further described in this disclosure interpretation component 118 may determine information that corresponds to STE 156, which computing device 116 and/or 134 may use to perform further operations, such as vehicle operations and/or analytics.

Interpretation unit 118 may determine one or more characteristics of vehicle pathway 106 from the primary information as well as the additional information. In other words, interpretation unit 118 may determine first characteristics of the vehicle pathway from the human-perceptible information on the pathway article, and determine second characteristics from the machine-perceptible information. For example, interpretation unit 118 may determine physical properties, such as the approximate shape of an impending set of curves in vehicle pathway 106 by interpreting the shape of arrow 126A. The shape of arrow 126A defining the approximate shape of the impending set of curves may be considered the primary information. The shape of arrow 126A may also be interpreted by a human occupant of PAAV 110A.

Interpretation component 118 may also determine additional characteristics of vehicle pathway 106 by interpreting other machine-readable portions of article message 126 or STE 154 of conspicuity tape 154. For example, by interpreting border information 126D and/or area 126F, interpretation component 118 may determine vehicle pathway 106 includes an incline along with a set of curves. Interpretation component 118 may signal computing device 116, which may cause vehicle control component 144 to prepare to increase power to maintain speed up the incline. Additional information from article message 126 may cause additional adjustments to one or more functions of PAAV 110A. Interpretation component 118 may determine other characteristics, such as a type of vehicle from STE 156 or change in road surface. Computing device 116 may determine these characteristics require a change to the vehicle suspension settings and cause vehicle control component 144 to perform the suspension setting adjustment. In some examples, interpretation component 118 may receive information on the relative position of lane markings to PAAV 110A and send signals to computing device 116 that cause vehicle control component 144 to apply a force to the steering to center PAAV 110A between the lane markings. Many other examples of interpretation component 118 determining characteristics of vehicle pathway 106 and changing operation of computing device 116 and/or vehicle 104A are possible.

The pathway article of this disclosure is just one piece of additional information that computing device 116, or a human operator, may consider when operating a vehicle. Other information may include information from other sensors, such as radar or ultrasound distance sensors, LiDAR sensors, wireless communications with other vehicles, lane markings on the vehicle pathway captured from image capture devices 102, information from GPS, and the like. Computing device 116 may consider the various inputs (p) and consider each with a weighting value, such as in a decision equation, as local information to improve the decision process. One possible decision equation may include:

D=w1*p1+w2*p2+wn*pn+wES*pES

where the weights (w1-wn) may be a function of the information received from the enhanced sign (pES). In the example of a construction zone, an enhanced sign may indicate a lane shift from the construction zone. Therefore, computing device 116 may de-prioritize signals from lane marking detection systems when operating the vehicle in the construction zone.

In some examples, PAAV 110A may be a test vehicle that may determine one or more characteristics of vehicle pathway 106 and may include additional sensors as well as components to communicate to a construction device such as construction device 138. As a test vehicle, PAAV 110A may be autonomous, remotely controlled, semi-autonomous or manually controlled. One example application may be to determine a change in vehicle pathway 106 near a construction zone. Once the construction zone workers mark the change with barriers, traffic cones or similar markings—any of which may include STEs—PAAV 110A may traverse the changed pathway to determine characteristics of the pathway. Some examples may include a lane shift, closed lanes, detour to an alternate route and similar changes. The computing device onboard the test device, such as computing device 116 onboard PAAV 110A, may assemble the characteristics of the vehicle pathway into data that contains the characteristics, or attributes, of the vehicle pathway.

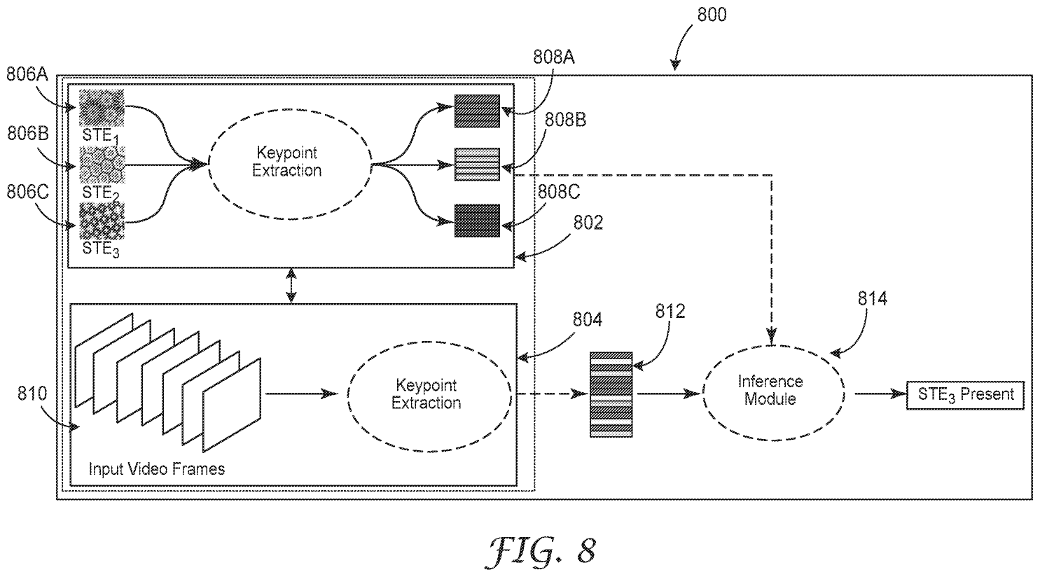

Computing devices 134 may represent one or more computing devices other than computing device 116. In some examples, computing devices 134 may or may not be communicatively coupled to one another. In some examples, one or more of computing devices 134 may or may not be communicatively coupled to computing device 116. Computing devices 134 may perform one or more operations in system 100 in accordance with techniques and articles of this system. For instance, computing devices 134 may generate and/or select one or more STEs as described in this disclosure, such as in FIG. 8 and other aspects of this disclosure. Computing devices 134 may send information that indicates one or more operations, rules, or other data that is usable by computing device 116 and/or vehicle 110A. For example, operations, rules, or other data may indicate vehicle operations, traffic or pathway conditions or characteristics, objects associated with a pathway, other vehicle or pedestrian information, or any other information usable by computing device 116 and/or vehicle 110A.

To design and make pathway articles, which may include STEs, computing device 134 may receive a printing specification that defines one or more properties of the pathway article, such as enhanced sign 108 and/or conspicuity tape 154. For example, computing device 134 may receive printing specification information included in the MUTCD from the U.S. DOT, or similar regulatory information found in other countries, that define the requirements for size, color, shape and other properties of pathway articles used on vehicle pathways. A printing specification may also include properties of manufacturing the barrier layer, retroreflective properties and other information that may be used to generate a pathway article. A printing specification may also include data that describes STEs including visual appearances of STEs and/or information associated with STEs. Machine-perceptible information may also include a confidence level of the accuracy of the machine-perceptible information. For example, a pathway marked out by a drone may not be as accurate as a pathway marked out by a test vehicle. Therefore, the dimensions of a radius of curvature, for example, may have a different confidence level based on the source of the data. The confidence level may impact the weighting of the decision equation described above.

Computing device 134 may generate construction data to form the article message on an optically active device, which will be described in more detail below. The construction data may be a combination of the printing specification and the characteristics of the vehicle pathway. Construction data generated by computing device 134 may cause construction device 138 to dispose the article message on a substrate in accordance with the printing specification and the data that indicates at least one characteristic of the vehicle pathway.

In the example of FIG. 1, PAAVs 110 may operate in a natural environment that includes pathway 106 and various other objects, such as other vehicles, pedestrians, pathway articles, buildings, landscapes and the like. Machine recognition may be used by computing device 116 for vehicle navigation, vehicle control, and other operations. System 100 may use structured texture embeddings (STEs) in retroreflective articles for machine recognition. As described above, retroreflective articles may be used in various vehicle and pathway applications, such as conspicuity tape that is applied to vehicles and pavement markings that are embodied on vehicle pathways. As an example, conspicuity tape may be applied to vehicles in order to enhance the visibility of the vehicle for other drivers, vehicles, and pedestrians. Conventionally, conspicuity tape may include a solid color or alternating stripe pattern to improve visibility of the conspicuity tape for humans. As vehicles, such as PAAVs 110, with fully- and semi-automated guidance systems become more prevalent on pathways, these guidance systems may rely on various sensing modalities including machine vision to recognize objects and react accordingly. Machine vision systems of computing device 116 may use feature recognition techniques, such as Scale-Invariant Feature Transform (SIFT) and Speeded Up Robust Features (SURF), to identify objects and/or object features in a scene for vehicle navigation and vehicle control, among other operations. Feature recognition techniques may identify features in a scene, which are then used to identify and/or classify objects based on the identified features.

Because vehicles may operate in natural environments with many features in a single scene (e.g., an image of a natural environment in which a vehicle operates at a particular point in time), feature recognition techniques may, at times, have difficulty identifying and/or classifying objects that are not sufficiently differentiated from other objects in a scene. In other words, in increasingly complex scenes, it may be more difficult for feature recognition techniques to identify and/or classify objects with sufficient confidence to make vehicle navigation and vehicle control decisions. Articles and techniques of this disclosure may include STEs (e.g., STE 156) in articles, such as conspicuity tape and pavement markings, that improve the identification and classification of objects when using feature recognition techniques. Rather than using a human constructed design (such as solid color or pattern for improved human visibility), which may not be easily differentiated from other object in a natural environment, techniques of this disclosure may generate STEs (e.g., STE 156) that are computationally generated for differentiation from features or objects in natural environments in which the article that includes the STE is used. For instance, STEs in this disclosure may be patterns or other arrangements of visual indicia computationally generated by one or more of computing devices 134 that are specifically and intentionally generated for an optimized or maximum differentiation from other features or objects in natural environments in which the article that includes the STE is used. By computationally increasing the amount of dissimilarity between the visual appearance of a particular STE from a natural environment scene (and/or other STEs), feature recognition techniques, such as Scale-Invariant Feature Transform (SIFT) and Speeded Up Robust Features (SURF), may identify and/or classify the object that includes the STE. In this way, improving the confidence levels of identification and/or classification of objects may improve vehicle navigation and vehicle control decisions, among other possible operations. Improving vehicle navigation and vehicle control decisions may improve vehicle and/or pedestrian safety, fuel consumption, and rider comfort.

In some examples, fully- and semi-automated guidance systems, such as implemented in computing device 116, may determine information that corresponds to an arrangement of features in the STE and perform operations based at least in part on the information that corresponds to the arrangement of features in the STE. For example, information that corresponds to an arrangement of features in the STE may indicate that an object (e.g., PAAV 110B) attached to the STE is an autonomous vehicle. As an example, an STE indicating an autonomous vehicle may be included in conspicuity tape 154 that is applied to PAAV 110B. When a fully- or semi-automated guidance system of a PAAV 110A identifies and classifies STE 156, including the information indicating autonomous vehicle PAAV 110B, computing device 116 of PAAV 110A may perform driving decisions to pass or otherwise overtake PAAV 110B with higher confidence because information indicating the type of object that PAAV 110A is passing or overtaking is available to the guidance system. In other examples, a type of object or physical dimensions (e.g., length, width, depth) of an object may be included as information in or associated with the arrangement of features in the STE. In this way, fully- and semi-automated guidance systems may rely on STEs to improve the confidence levels of identification and/or classification of objects in a natural scene, but also use additional information from the STE to make vehicle navigation and vehicle control decisions.

As shown in FIG. 1, pathway 106 may include pavement markings 150. PAAV 110B may include conspicuity tape 154. Pavement marking 150 may include one or more STEs 152. Conspicuity tape 154 may include one or more STEs 156. Pathway article 108 may include one or more STEs. PAAV 110A may capture images of STEs 152, 154, 156. Computing device 116 may identify a Structured Texture Embedding and perform one or more operations based on the Structured Texture Embedding. For instance, computing device 116 may determine a vehicle type based on the type of STE. In some examples, computing device 116 may determine that a type of STE pattern indicates that a vehicle to which the STE pattern is attached is part of a vehicle platoon, where one vehicle in a set of vehicles controls or influences the operation of all the vehicles in the set. In some examples, computing device 116 may determine a permitted level of autonomous driving based on an STE in a pavement marking.

In accordance with techniques of this disclosure, an article, such as conspicuity tape 156, may include a retroreflective substrate; and a structured texture element embodied on the retroreflective substrate. The visual appearance of the structured texture element may be computationally generated for differentiation from a visual appearance of a natural environment scene for the article. As described in FIG. 1, the article may be any pathway article or other physical object. Techniques for computationally generating STEs for differentiation from the appearance of a natural environment scene and/or other STEs are described in this disclosure, such as in FIG. 8. For example, computing device 134 may generate one or more one or more STEs where the visual appearance of a structured texture elements is computationally generated for differentiation from a visual appearance of a natural environment scene for the article of conspicuity tape and/or one or more other STEs. A visual appearance may be one or more visual features, characteristics or properties. Examples of visual features, characteristics, or properties may include but are not limited to: shapes; colors; curves; points; segments; patterns; luminance; visibility in particular light wavelength spectrums; sizes of any features, characteristics, or properties; or widths or lengths of any features, characteristics, or properties.

Computing device 134 may computationally generate or select one or more of STEs that have one or more features, characteristics, or properties in a repeating pattern or non-repeating arrangement. To computationally generate STEs for differentiation from a visual appearance of a natural environment scene and/or other STEs, computing device 134 may generate or select one or more STEs. Computing device 134 may apply feature recognition techniques, such as keypoint extraction or other suitable techniques, to a set of images or video. Based on the confidence level or amount of detection elements that match a particular STE, computing device 134 may associate a score or other indicator of the degree of differentiation between the particular STE and one or more (a) natural scenes that include the particular STE, and/or (b) one or more other STEs. Detection elements may be any feature or indicia of an image, and may include keypoints in a SIFT technique or features in a feature map of a convolutional neural network technique to name only a few examples. In this way, computing device 134 may select or generate multiple different STEs and simulate which STEs will be more differentiable from natural scenes and/or other STEs. In some examples, differentiation between the particular STE and (a) natural scenes that include the particular STE, and/or (b) one or more other STEs, may be based on a degree of visual similarity or visual difference between the particular STE and (a) natural scenes that include the particular STE, and/or (b) one or more other STEs. The degree of visual similarity may be based on the difference in pixel values, blocks within an image, or other suitable image comparison techniques.

In some examples, computing device 134 may generate feedback data for a particular STE that includes but is not limited to: data that indicates whether a particular STE that satisfies differentiation threshold, a degree of differentiation of the particular STE, an identifier of the particular STE, an identifier of a natural scene, an identifier of another STE, or any other information usable by computing device 134 to generate one or more STEs. Computing device 134 may use feedback data to change the visual appearance of one or more new STE that are generated such that the one or more new STEs have greater differentiability from other previously simulated STEs. Computing device 134 may use the feedback data to alter the visual appearances of the one or more new STEs, such that the visual differentiation increases between the new STEs and the previously simulated STE. In this way, STEs can be generated that have greater amounts or degrees of visual differentiation from natural scenes and/or other STEs.

In some examples, a natural environment scene is an image, set of images, or field of view generated by an image capture device. The natural environment scene may be an image of an actual, physical natural environment or a simulated environment. The natural environment scene may be an image of a pathway and/or its surroundings, scenery, or conditions. For example, a natural environment scene may be an image of an urban setting with buildings, sidewalks, pathways, and associated objects (e.g., vehicles, pedestrians, pathway articles, to name only a few examples). Another natural environment scene may be an image of a highway or expressway with guardrails, surrounding fields, pathway shoulder areas, and associated objects (e.g., vehicles, pedestrians, pathway articles, to name only a few examples). Any number and variations of natural environment scenes are possible. Conventionally, pathway articles may, in some circumstances, be difficult for computing devices to identify or discern from other objects or features in a natural environment scene. By computationally generating and including structured texture elements that are generated for differentiation from a visual appearance of a natural environment scene, techniques of this disclosure may improve the ability of machine recognition systems to identify articles, and in some examples, perform operations based on recognition of the articles.

In some examples, first and second structured texture elements are included in a set of structured texture elements. Although various examples may refer to “first” and “second” structured texture elements, any number of structured texture elements may be used. Each respective structured texture element included in the set of structured texture elements is computationally generated for differentiation from each other structured texture element in the set of structured texture elements. In this way, the structure texture elements may be more easily distinguished from one another by a machine recognition system. In some examples, each respective structured texture element included in the set of structured texture elements is computationally generated for differentiation from a natural environment scene and each other structured texture element in the set of structured texture elements. In this way, the structure texture elements may be more easily distinguished from one another and the natural environment scene by a machine recognition system. In some examples, the first and second structured texture element are computationally generated for differentiation from one another to satisfy a threshold amount of differentiation. The threshold amount of differentiation may be a maximum amount of differentiation. The threshold amount of differentiation may be use configured or machine generated. The maximum amount of differentiation may be a largest amount of dissimilarity between the visual appearance of the first structured texture element and the visual appearance of the second structured texture element.

In some examples, the first structured texture element may be computationally generated (e.g., by computing device 134) to produce a first set of keypoints from a first image and the second structured texture element may be computationally generated to produce a second set of keypoints from a second image. The first and second structured texture elements are computationally generated to differentiate the first set of keypoints from the second set of keypoints. Keypoints may represent, correspond to, or identify visual features that are present in a particular STE. The first set of keypoints may be computationally generated for differentiation from the second set of keypoints to satisfy a threshold amount of differentiation. The threshold amount of differentiation may be a maximum amount of differentiation.

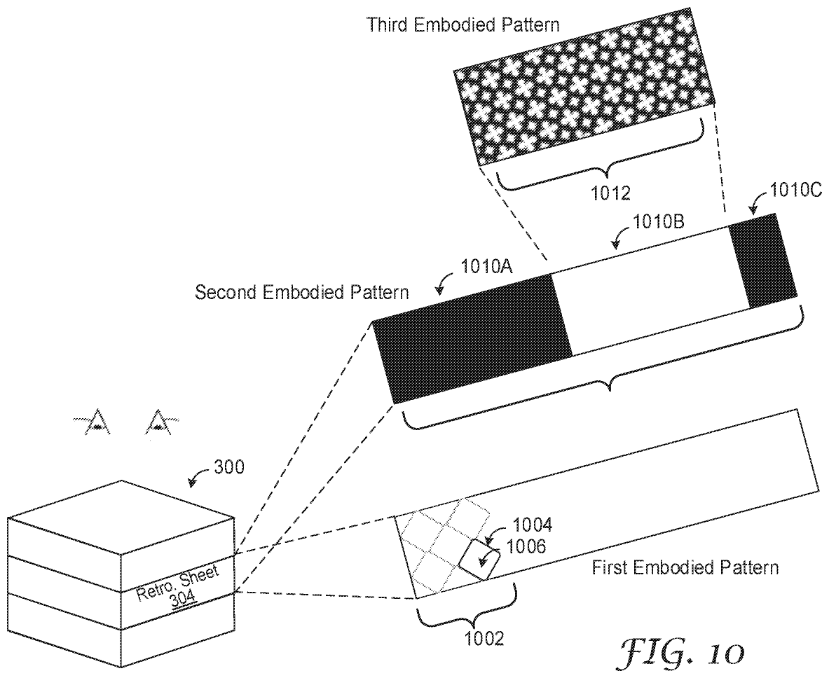

In some examples, a pathway article, such as conspicuity tape 156 may include one or more patterns. The structured texture element may be a first pattern. The pathway article may include a second pattern that is a seal pattern. The seal pattern may define one or more sealed areas of the pathway article, such as illustrated in FIG. 10. In some examples, a structured texture element may be first pattern, and the pathway article may include a second pattern that is a printed pattern of one or more inks on the article that are different from the first pattern. In some examples, the printed pattern of one or more inks may be a solid pattern. In some examples, a structured texture element is visible in a spectral range of approximately 350 nm to 750 nm. In some examples, a structured texture element is visible in at least one spectral range that is outside approximately 350 nm to 750 nm. In some examples, a structured texture element is visible in at least one spectral range that is outside approximately 350 nm to 750 nm. In some examples, a structured texture element is visible within a spectral range of approximately 700 nm to 1100 nm. In some examples, “approximately” may mean+/−10, 15, or 50 nm of a range bound. In some examples, “approximately” may mean+/−1, 5, or 10 percent of a range bound.

In some examples, a structured texture element is configurable with information descriptive of an object that corresponds to the article. For example, information may be encoded within the structured texture element. The information may identify or characterize the object, such as described in various examples of this disclosure (e.g., vehicle type, object properties, etc.). In some examples, the information descriptive of an object that corresponds to the article may be associated with the structured texture element. For example, a computing device may store data that indicates an association between the structured texture element and the information descriptive of an object. If a particular structured texture embedding is identified or selected, the associated information descriptive of the object may be retrieved, transmitted or other processed in further operations. In some examples, the information descriptive of the object indicates an object in a vehicle platoon. In some examples, the information descriptive of the object indicates an autonomous vehicle.

Although several examples have been described above, any number of operations may be performed in response to identifying an STE. In some examples, the information descriptive of the object indicates information configured for an autonomous vehicle. In some examples, the information descriptive of the object indicates at least one of a size or type of the object. In some examples, the object is at least one of a vehicle or a second object associated with the vehicle. In some examples, the information descriptive of the object comprises an identifier associated with the object. In some examples, the article of conspicuity tape is attached to the object that corresponds to the article of conspicuity tape.

This disclosure also describes systems and techniques for identifying and using structure-text embeddings. For example, FIG. 1 illustrates a system comprising a light capture device, such as image capture component 102C and computing device 116 communicatively coupled to image capture component 102C. Computing device 116 may receive, from image capture component 102C, retroreflected light that indicates a structured texture element (e.g., in conspicuity tape 154) embodied on a retroreflective article, wherein a visual appearance of the structured texture element is computationally generated for differentiation from a visual appearance of a natural environment scene that includes the article. Computing device 116 may determine information that corresponds to an arrangement of features in the STE. Examples of such information are described in this disclosure (e.g., vehicle type, object properties, etc.). Computing device 116 may perform one or more operations based at least in part on the information that corresponds to the arrangement of features in the STE. The arrangement of features in the STE may include a repeating pattern or non-repeating arrangement of one or more visual features, characteristics or properties.

In some examples, to perform at least one operation that is based at least in part on the information that corresponds to the arrangement of features in the STE computing device 116 may be configured to select a level of autonomous driving for a vehicle that includes the computing device. In some examples, to perform at least one operation that is based at least in part on the information that corresponds to the arrangement of features in the STE computing device 116 may be configured to change or initiate one or more operations of vehicle 110A. Vehicle operations may include but are not limited to: generating visual/audible/haptic outputs, braking functions, acceleration functions, turning functions, vehicle-to-vehicle and/or vehicle-to-infrastructure and/or vehicle-to-pedestrian communications, or any other operations.

Although SIFT has been used in this disclosure for example purposes, other feature recognition techniques including supervised and unsupervised learning techniques, such as neural networks and deep learning to name only a few non-limiting examples, may also be used in accordance with techniques of this disclosure. In such examples, a computing device may apply image data that represents the visual appearance of the structured texture element to a model and generate, based at least in part on application of the image data to the model, information that indicates the structured texture element. For instance, the model may classify or otherwise identify the particular STE based on the image data. In some examples, the model has been trained based at least in part on one or more training images comprising the structured texture element. The model may be configured based on at least one of a supervised, semi-supervised, or unsupervised technique. Example techniques may include deep learning techniques described in: (a) “A Survey on Image Classification and Activity Recognition using Deep Convolutional Neural Network Architecture”, 2017 Ninth International Conference on Advanced Computing (ICoAC), M. Sornam et al., pp. 121-126; (b) “Visualizing and Understanding Convolutional Networks”, arXiv:1311.2901v3 [cs.CV] 28 Nov. 2013, Zeiler et al.; (c) “Understanding of a Convolutional Neural Network”, ICET2017, Antalya, Turkey, Albawi et al., the contents of each of which are hereby incorporated by reference herein in their entirety. Other techniques that may be used in accordance with techniques of this disclosure include but are not limited to Bayesian algorithms, clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

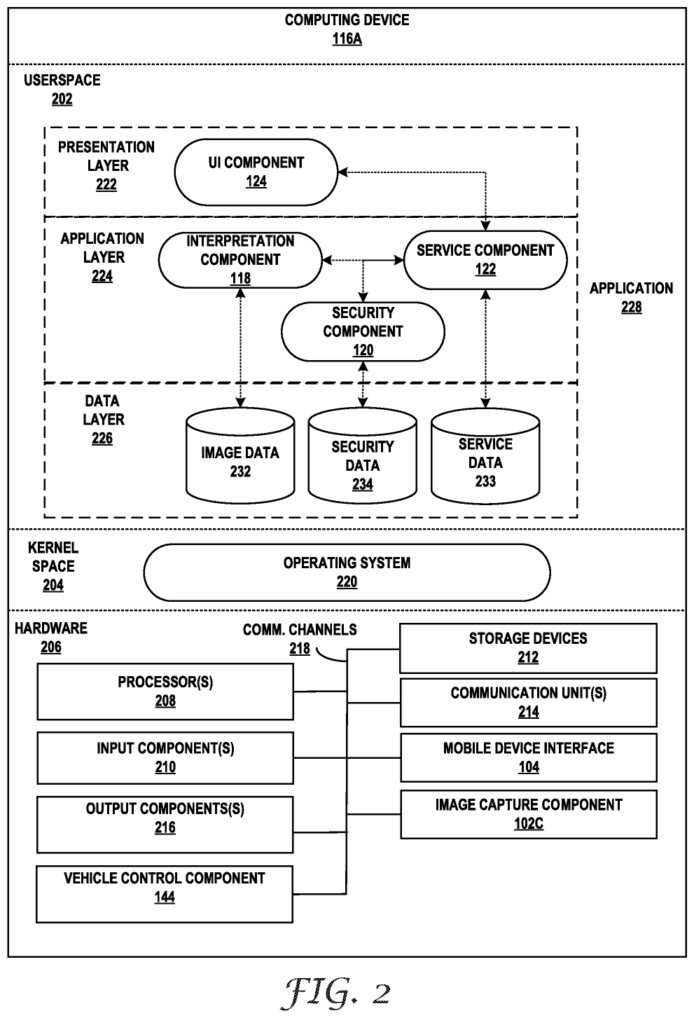

FIG. 2 is a block diagram illustrating an example computing device, in accordance with one or more aspects of the present disclosure. FIG. 2 illustrates only one example of a computing device. Many other examples of computing device 116 may be used in other instances and may include a subset of the components included in example computing device 116 or may include additional components not shown example computing device 116 in FIG. 2.

In some examples, computing device 116 may be an in in-vehicle computing device or in-vehicle sub-system, server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard PAAV 110A, depicted in FIG. 1. In other examples, computing device 116 may also be part of a system or device that produces signs and correspond to computing device 134 depicted in FIG. 1.

As shown in the example of FIG. 2, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202. In some examples, any components, functions, operations, and/or data may be included or executed in kernel space 204 and/or implemented as hardware components in hardware 206. Although application 228 is illustrated as an application executing in userspace 202, different portions of application 228 and its associated functionality may be implemented in hardware and/or software (userspace and/or kernel space).

As shown in FIG. 2, hardware 206 includes one or more processors 208, input components 210, storage devices 212, communication units 214, output components 216, mobile device interface 104, image capture component 102C, and vehicle control component 144. Processors 208, input components 210, storage devices 212, communication units 214, output components 216, mobile device interface 104, image capture component 102C, and vehicle control component 144 may each be interconnected by one or more communication channels 218. Communication channels 218 may interconnect each of the components 102C, 104, 208, 210, 212, 214, 216, and 144 for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of computing device 116 may receive input. Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes one or more characteristics of a vehicle pathway. As described in FIG. 1, for purposes of this disclosure, references to determinations about vehicle pathway 106 and/or characteristics of vehicle pathway 106 may include determinations about vehicle pathway 106 and/or objects at or near pathway 106 including characteristics of vehicle pathway 106 and/or objects at or near pathway 106, such as but not limited to other vehicles, pedestrians, or objects. In examples where computing device 116 is part of a vehicle, such as PAAV 110A depicted in FIG. 1, communication units 214 may receive information about a pathway article that includes an STE from an image capture device, as described in relation to FIG. 1. In other examples, such as examples where computing device 116 is part of a system or device that produces signs, communication units 214 may receive data from a test vehicle, handheld device or other means that may gather data that indicates the characteristics of a vehicle pathway, as described above in FIG. 1 and in more detail below. Computing device 116 may receive updated information, upgrades to software, firmware and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116, but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Hardware 206 may also include vehicle control component 144, in examples where computing device 116 is onboard a PAAV. Vehicle control component 144 may have the same or similar functions as vehicle control component 144 described in relation to FIG. 1.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 2, application 228 executes in userspace 202 of computing device 116. Application 228 may be logically divided into presentation layer 222, application layer 224, and data layer 226. Presentation layer 222 may include user interface (UI) component 228, which generates and renders user interfaces of application 228. Application 228 may include, but is not limited to: UI component 124, interpretation component 118, security component 120, and one or more service components 122. For instance, application layer 224 may interpretation component 118, service component 122, and security component 120. Presentation layer 222 may include UI component 124.

Data layer 226 may include one or more datastores. A datastore may store data in structure or unstructured form. Example datastores may be any one or more of a relational database management system, online analytical processing database, table, or any other suitable structure for storing data.

Security data 234 may include data specifying one or more validation functions and/or validation configurations. Service data 233 may include any data to provide and/or resulting from providing a service of service component 122. For instance, service data may include information about pathway articles (e.g., security specifications), user information, or any other information. Image data 232 may include one or more images that are received from one or more image capture devices, such as image capture devices 102 described in relation to FIG. 1. In some examples, the images are bitmaps, Joint Photographic Experts Group images (JPEGs), Portable Network Graphics images (PNGs), or any other suitable graphics file formats.

In the example of FIG. 2, one or more of communication units 214 may receive, from an image capture device, an image of a pathway article that includes an article message, such as article message 126 in FIG. 1. In some examples, UI component 124 or any one or more components of application layer 224 may receive the image of the pathway article and store the image in image data 232.

In response to receiving the image, interpretation component 118 may determine whether a structured texture embedding is included in an image selected from image data 232. Image data 232 may include images or video of a natural environment scene captured by image capture component 102C. Image data 232 may include information that indicates associations between structured texture embeddings and keypoints or other features. Using feature recognition techniques described in this disclosure, interpretation component may determine that one or more structured texture embeddings are included in one or more images. Interpretation component 118, may apply one or more feature recognition techniques to extract keypoints that correspond respectively to STEs. Keypoints may represent, correspond to, or identify visual features that are present in a particular STE. As such keypoints may be processed by one or more feature recognition techniques of interpretation component 118 to determine that an image includes a particular STE. Interpretation component 118 may process one or more of images using feature recognition techniques to determine that an image includes a different sub-sets of keypoints. Interpretation component 118 may apply one or more techniques to determine, based on keypoints, which STE(s) are present (if any) in a image or set of images. Such techniques may include determining which sub-set of keypoints has the highest number of keypoints that correspond to or match keypoints for a particular STE, determining which sub-set has the highest probability of keypoints that correspond to or match keypoints for a particular STE, or any other suitable selection technique to determine that a particular STE corresponds to the extracted keypoints. Interpretation component 118 may, using the selection technique, output an identifier or other data that indicates the STE corresponding to one or more of keypoints 812.

Interpretation component 118 may also determine one or more characteristics of a vehicle pathway and transmit data representative of the characteristics to other components of computing device 116, such as service component 122. Interpretation component 118 may determine the characteristics of the vehicle pathway indicate an adjustment to one or more functions of the vehicle, in some examples, using STEs. For example, an STE may indicate that a vehicle including computing device 116 is approaching a vehicle platoon based on information associated with an STE attached to a portion of the platoon. Computing device 116 may combine this information with other information from other sensors, such as image capture devices, GPS information, information from network 114 and similar information to adjust vehicle operations including but not limited to the speed, suspension or other functions of the vehicle through vehicle control component 144.

Similarly, computing device 116 may determine one or more conditions of the vehicle. Vehicle conditions may include a weight of the vehicle, a position of a load within the vehicle, a tire pressure of one or more vehicle tires, transmission setting of the vehicle and a powertrain status of the vehicle. For example, a PAAV with a large powertrain may receive different commands when encountering an incline in the vehicle pathway than a PAAV with a less powerful powertrain (i.e. motor).

Computing device 116 may also determine environmental conditions in a vicinity of the vehicle. Environmental conditions may include air temperature, precipitation level, precipitation type, incline of the vehicle pathway, presence of other vehicles and estimated friction level between the vehicle tires and the vehicle pathway.

Computing device 116 may combine information from STEs, vehicle conditions, environmental conditions, interpretation component 118 and other sensors to determine adjustments to the state of one or more functions of the vehicle, such as by operation of vehicle control component 144, which may interoperate with any components and/or data of application 228. For example, interpretation component 118 may determine the vehicle is approaching a curve with a downgrade, based on interpreting a sign with an STE on the vehicle pathway. Computing device 116 may determine one speed for dry conditions and a different speed for wet conditions. Similarly, computing device 116 onboard a heavily loaded freight truck may determine one speed while computing device 116 onboard a sports car may determine a different speed.

In some examples, computing device 116 may determine the condition of the pathway by considering a traction control history of a PAAV. For example, if the traction control system of a PAAV is very active, computing device 116 may determine the friction between the pathway and the vehicle tires is low, such as during a snow storm or sleet.

The pathway articles of this disclosure may include one or more security elements which may be implemented in STEs, such as security element 126E depicted in FIG. 1, to help determine if the pathway article is counterfeit. Security is a concern with intelligent infrastructure to minimize the impact of hackers, terrorist activity or crime. For example, a criminal may attempt to redirect an autonomous freight truck to an alternate route to steal the cargo from the truck. An invalid security check may cause computing device 116 to give little or no weight to the information in the sign as part of the decision equation to control a PAAV.

As discussed above, for the machine-readable portions of the article message, the properties of security marks may include but are not limited to location, size, shape, pattern, composition, retroreflective properties, appearance under a given wavelength, or any other spatial characteristic of one or more security marks. Security component 120 may determine whether pathway article, such as enhanced sign 108 is counterfeit based at least in part on determining whether the at least one symbol, such as the graphical symbol, is valid for at least one security element included in an STE. As described in relation to FIG. 1 security component 120 may include one or more validation functions and/or one or more validation conditions on which the construction of enhanced sign 108 is based. In some examples a fiducial marker, such as fiducial tag 126C may act as a security element. In other examples a pathway article may include one or more security elements such as security element 126E.

In FIG. 2, security component 120 determines, using a validation function based on the validation condition in security data 234, whether the pathway article depicted in FIG. 1 is counterfeit. Security component 120, based on determining that the security elements in an STE satisfy the validation configuration, generate data that indicates enhanced sign 108 is authentic (e.g., not a counterfeit). If security elements and the article message in enhanced sign 108 did not satisfy the validation criteria, security component 120 may generate data that indicates pathway article is not authentic (e.g., counterfeit) or that the pathway article is not being read correctly.

A pathway article may not be read correctly because it may be partially occluded or blocked, the image may be distorted or the pathway article is damaged. For example, in heavy snow or fog, or along a hot highway subject to distortion from heat rising from the pathway surface, the image of the pathway article may be distorted. In another example, another vehicle, such as a large truck, or a fallen tree limb may partially obscure the pathway article. The security elements included in the STE, or other components of the article message, may help determine if an enhanced sign is damaged. If the security elements are damaged or distorted, security component 120 may determine the enhanced sign is invalid.

For some examples of computer vision systems, such as may be part of PAAV 110A, the pathway article may be visible in hundreds of frames as the vehicle approaches the enhanced sign. The interpretation of the enhanced sign may not necessarily rely on a single, successful capture image. At a far distance, the system may recognize the enhanced sign. As the vehicle gets closer, the resolution may improve and the confidence in the interpretation of the sign information may increase. The confidence in the interpretation may impact the weighting of the decision equation and the outputs from vehicle control component 144.

Service component 122 may perform one or more operations based on the data generated by security component 120 and/or interpretation component 118. Service component 122 may, for example, query service data 233 to retrieve a list of recipients for sending a notification or store information that indicates details of the image of the pathway article (e.g., object to which pathway article is attached, image itself, metadata of image (e.g., time, date, location, etc.)). In response to, for example, determining that the pathway article is a counterfeit, service component 122 may send data to UI component 124 that causes UI component 124 to generate an alert for display. UI component 124 may send data to an output component of output components 216 that causes the output component to display the alert. In other examples, service component 122 may use service data 233 that includes information indicating one or more operations, rules, or other data that is usable by computing device 116 and/or vehicle 110A. For example, operations, rules, or other data may indicate vehicle operations, traffic or pathway conditions or characteristics, objects associated with a pathway, other vehicle or pedestrian information, or any other information usable by computing device 116 and/or vehicle 110A.

Similarly, service component 122, or some other component of computing device 116, may cause a message to be sent through communication units 214. The message could include any information, such as whether an article is counterfeit, operations taken by a vehicle, information associated with an STE, whether an STE was identified, to name only a few examples, and any information described in this disclosure may be sent in such message. In some examples the message may be sent to law enforcement, those responsible for maintenance of the vehicle pathway and to other vehicles, such as vehicles nearby the pathway article.

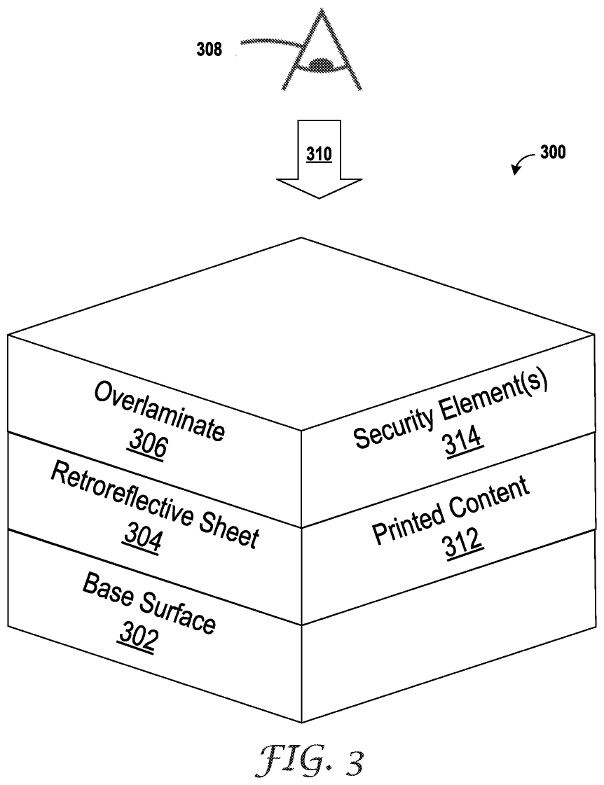

FIG. 3 is a conceptual diagram of a cross-sectional view of a pathway article in accordance with techniques of this disclosure. In some examples, such as an enhanced sign, a pathway article may comprise multiple layers. For purposes of illustration in FIG. 3, a pathway article 300 may include a base surface 302. Base surface 302 may be an aluminum plate or any other rigid, semi-rigid, or flexible surface. Retroreflective sheet 304 may be a retroreflective sheet as described in this disclosure. A layer of adhesive (not shown) may be disposed between retroreflective sheet 304 and base surface 302 to adhere retroreflective sheet 304 to base surface 302.

Pathway article may include an overlaminate 306 that is formed or adhered to retroreflective sheet 304. Overlaminate 306 may be constructed of a visibly-transparent, infrared opaque material, such as but not limited to multilayer optical film as disclosed in U.S. Pat. No. 8,865,293, which is expressly incorporated by reference herein in its entirety. In some construction processes, retroreflective sheet 304 may be printed and then overlaminate 306 subsequently applied to reflective sheet 304. A viewer 308, such as a person or image capture device, may view pathway article 300 in the direction indicated by the arrow 310.

As described in this disclosure, in some examples, an article message, which may include or be an STE, may be printed or otherwise included on a retroreflective sheet. An overlaminate may be applied over the retroreflective sheet. In some examples, the overlaminate may not contain an article message. In the example of FIG. 3, visible portions 312 of the article message may be included in retroreflective sheet 304, but non-visible portions 314 of the article message may be included in overlaminate 306. In some examples, a non-visible portion may be created from or within a visibly-transparent, infrared opaque material that forms an overlaminate. European publication No. EP0416742 describes recognition symbols created from a material that is absorptive in the near infrared spectrum but transparent in the visible spectrum. Suitable near infrared absorbers/visible transmitter materials include dyes disclosed in U.S. Pat. No. 4,581,325. U.S. Pat. No. 7,387,393 describes license plates including infrared-blocking materials that create contrast on a license plate. U.S. Pat. No. 8,865,293 describes positioning an infrared-reflecting material adjacent to a retroreflective or reflective substrate, such that the infrared-reflecting material forms a pattern that can be read by an infrared sensor when the substrate is illuminated by an infrared radiation source. EP0416742 and U.S. Pat. Nos. 4,581,325, 7,387,393 and 8,865,293 are herein expressly incorporated by reference in their entireties. In some examples, overlaminate 306 may be etched with one or more visible or non-visible portions.

In some examples, if overlaminate includes non-visible portions 314 and retroreflective sheet 304 includes visible portions 312 of article message, an image capture device may capture two separate images, where each separate image is captured under a different lighting spectrum or lighting condition. For instance, the image capture device may capture a first image under a first lighting spectrum that spans a lower boundary of infrared light to an upper boundary of 900 nm. The first image may indicate which encoding units are active or inactive. The image capture device may capture a second image under a second lighting spectrum that spans a lower boundary of 900 nm to an upper boundary of infrared light. The second image may indicate which portions of the article message are active or inactive (or present or not present). Any suitable boundary values may be used. In some examples, multiple layers of overlaminate, rather than a single layer of overlaminate 306, may be disposed on retroreflective sheet 304. One or more of the multiple layers of overlaminate may have one or more portions of the article message. Techniques described in this disclosure with respect to the article message may be applied to any of the examples described in FIG. 3 with multiple layers of overlaminate.

In some examples, a laser in a construction device, such as construction device as described in this disclosure, may engrave the article message onto sheeting, which enables embedding markers specifically for predetermined meanings. Example techniques are described in U.S. Provisional Patent Application 62/264,763, filed on Dec. 8, 2015, which is hereby incorporated by reference in its entirety. In such examples, the portions of the article message in the pathway article can be added at print time, rather than being encoded during sheeting manufacture. In some examples, an image capture device may capture an image in which the engraved security elements or other portions of the article message are distinguishable from other content of the pathway article. In some examples the article message may be disposed on the sheeting at a fixed location while in other examples, the article message may be disposed on the sheeting using a mobile construction device, as described above.

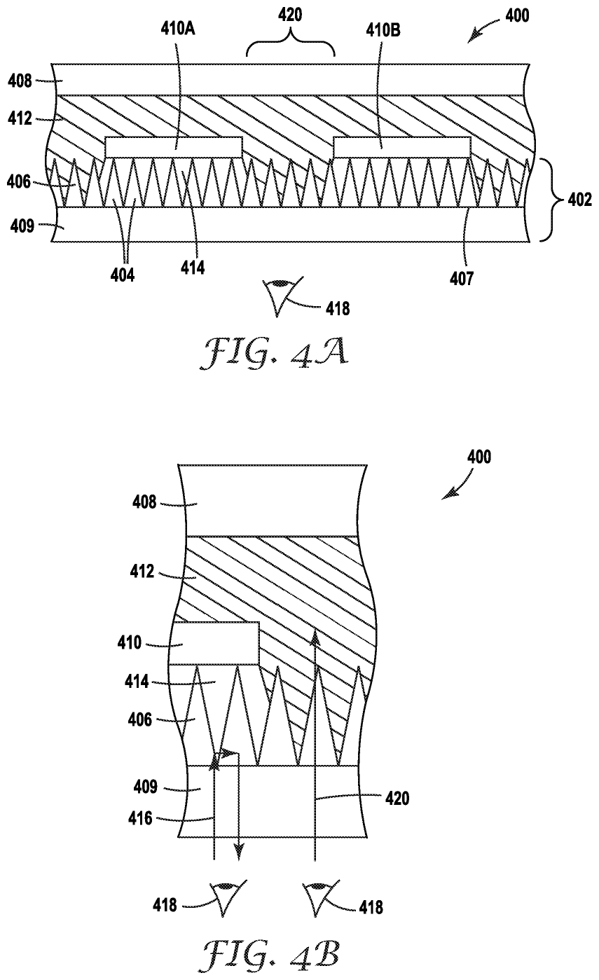

FIGS. 4A and 4B illustrate cross-sectional views of portions of an article message formed on a retroreflective sheet, in accordance with one or more techniques of this disclosure. As described in this disclosure, an article message may include or be an STE. Retroreflective article 400 includes a retroreflective layer 402 including multiple cube corner elements 404 that collectively form a structured surface 406 opposite a major surface 407. The optical elements can be full cubes, truncated cubes, or preferred geometry (PG) cubes as described in, for example, U.S. Pat. No. 7,422,334, incorporated herein by reference in its entirety. The specific retroreflective layer 402 shown in FIGS. 4A and 4B includes a body layer 409, but those of skill will appreciate that some examples do not include an overlay layer. One or more barrier layers 410 are positioned between retroreflective layer 402 and conforming layer 412, creating a low refractive index area 414. Barrier layers 410 form a physical “barrier” between cube corner elements 404 and conforming layer 412. Barrier layer 410 can directly contact or be spaced apart from or can push slightly into the tips of cube corner elements 404. Barrier layers 410 have a characteristic that varies from a characteristic in one of (1) the areas 412 not including barrier layers (view line of light ray 416) or (2) another barrier layer 412. Exemplary characteristics include, for example, color and infrared absorbency.

In general, any material that prevents the conforming layer material from contacting cube corner elements 404 or flowing or creeping into low refractive index area 414 can be used to form the barrier layer Exemplary materials for use in barrier layer 410 include resins, polymeric materials, dyes, inks (including color-shifting inks), vinyl, inorganic materials, UV-curable polymers, multi-layer optical films (including, for example, color-shifting multi-layer optical films), pigments, particles, and beads. The size and spacing of the one or more barrier layers can be varied. In some examples, the barrier layers may form a pattern on the retroreflective sheet. In some examples, one may wish to reduce the visibility of the pattern on the sheeting. In general, any desired pattern can be generated by combinations of the described techniques, including, for example, indicia such as letters, words, alphanumerics, symbols, graphics, logos, or pictures. The patterns can also be continuous, discontinuous, monotonic, dotted, serpentine, any smoothly varying function, stripes, varying in the machine direction, the transverse direction, or both; the pattern can form an image, logo, or text, and the pattern can include patterned coatings and/or perforations. The pattern can include, for example, an irregular pattern, a regular pattern, a grid, words, graphics, images lines, and intersecting zones that form cells.

The low refractive index area 414 is positioned between (1) one or both of barrier layer 410 and conforming layer 412 and (2) cube corner elements 404. The low refractive index area 414 facilitates total internal reflection such that light that is incident on cube corner elements 404 adjacent to a low refractive index area 414 is retroreflected. As is shown in FIG. 4B, a light ray 416 incident on a cube corner element 404 that is adjacent to low refractive index layer 414 is retroreflected back to viewer 418. For this reason, an area of retroreflective article 400 that includes low refractive index layer 414 can be referred to as an optically active area. In contrast, an area of retroreflective article 400 that does not include low refractive index layer 414 can be referred to as an optically inactive area because it does not substantially retroreflect incident light. As used herein, the term “optically inactive area” refers to an area that is at least 50% less optically active (e.g., retroreflective) than an optically active area. In some examples, the optically inactive area is at least 40% less optically active, or at least 30% less optically active, or at least 20% less optically active, or at least 10% less optically active, or at least at least 5% less optically active than an optically active area.

Low refractive index layer 414 includes a material that has a refractive index that is less than about 1.30, less than about 1.25, less than about 1.2, less than about 1.15, less than about 1.10, or less than about 1.05. In general, any material that prevents the conforming layer material from contacting cube corner elements 404 or flowing or creeping into low refractive index area 414 can be used as the low refractive index material. In some examples, barrier layer 410 has sufficient structural integrity to prevent conforming layer 412 from flowing into a low refractive index area 414. In such examples, low refractive index area may include, for example, a gas (e.g., air, nitrogen, argon, and the like). In other examples, low refractive index area includes a solid or liquid substance that can flow into or be pressed into or onto cube corner elements 404. Exemplary materials include, for example, ultra-low index coatings (those described in PCT Patent Application No. PCT/US2010/031290), and gels.

The portions of conforming layer 412 that are adjacent to or in contact with cube corner elements 404 form non-optically active (e.g., non-retroreflective) areas or cells. In some examples, conforming layer 412 is optically opaque. In some examples conforming layer 412 has a white color.

In some examples, conforming layer 412 is an adhesive. Exemplary adhesives include those described in PCT Patent Application No. PCT/US2010/031290. Where the conforming layer is an adhesive, the conforming layer may assist in holding the entire retroreflective construction together and/or the viscoelastic nature of barrier layers 410 may prevent wetting of cube tips or surfaces either initially during fabrication of the retroreflective article or over time.

In some examples, conforming layer 412 is a pressure sensitive adhesive. The PSTC (pressure sensitive tape council) definition of a pressure sensitive adhesive is an adhesive that is permanently tacky at room temperature which adheres to a variety of surfaces with light pressure (finger pressure) with no phase change (liquid to solid). While most adhesives (e.g., hot melt adhesives) require both heat and pressure to conform, pressure sensitive adhesives typically only require pressure to conform. Exemplary pressure sensitive adhesives include those described in U.S. Pat. No. 6,677,030. Barrier layers 410 may also prevent the pressure sensitive adhesive from wetting out the cube corner sheeting. In other examples, conforming layer 412 is a hot-melt adhesive.

In some examples, a pathway article may use a non-permanent adhesive to attach the article message to the base surface. This may allow the base surface to be re-used for a different article message. Non-permanent adhesive may have advantages in areas such as roadway construction zones where the vehicle pathway may change frequently.

In the example of FIG. 4A, a non-barrier region 420 does not include a barrier layer, such as barrier layer 410. As such, light may reflect with a lower intensity than barrier layers 410A-410B. In some examples, non-barrier region 420 may correspond to an “active” security element. For instance, the entire region or substantially all of image region 142A may be a non-barrier region 420. In some examples, substantially all of image region 142A may be a non-barrier region that covers at least 50% of the area of image region 142A. In some examples, substantially all of image region 142A may be a non-barrier region that covers at least 75% of the area of image region 142A. In some examples, substantially all of image region 142A may be a non-barrier region that covers at least 90% of the area of image region 142A. In some examples, a set of barrier layers (e.g., 410A, 410B) may correspond to an “inactive” security element as described in FIG. 1. In the aforementioned example, an “inactive” security element as described in FIG. 1 may have its entire region or substantially all of image region 142D filled with barrier layers. In some examples, substantially all of image region 142D may be a non-barrier region that covers at least 75% of the area of image region 142D. In some examples, substantially all of image region 142D may be a non-barrier region that covers at least 90% of the area of image region 142D. In the foregoing description of FIG. 4 with respect to security layers, in some examples, non-barrier region 420 may correspond to an “inactive” security element while an “active” security element may have its entire region or substantially all of image region 142D filled with barrier layers.

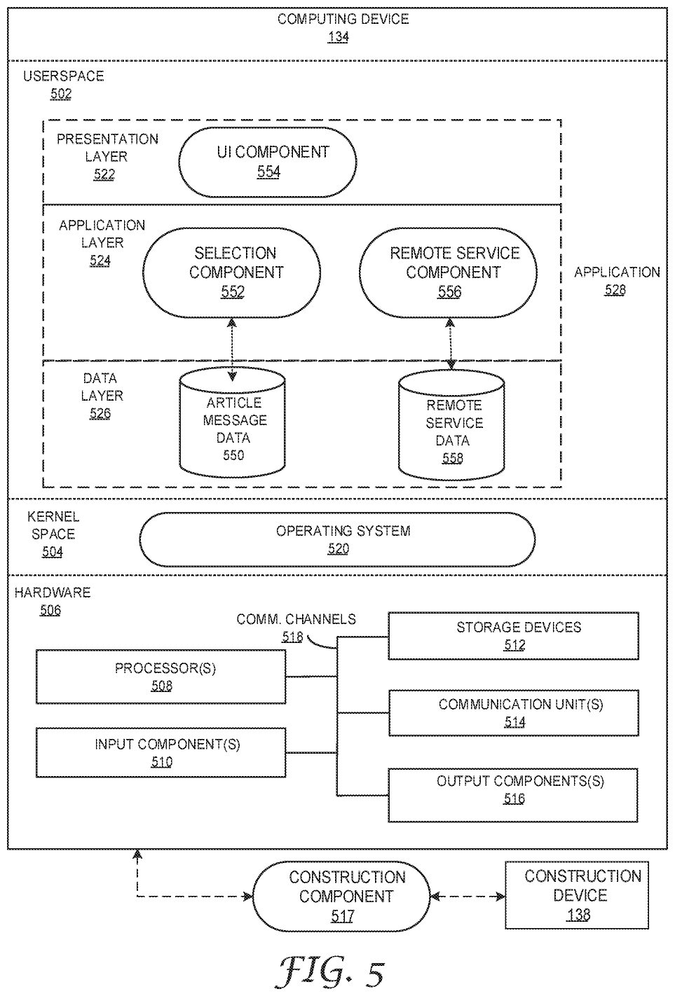

FIG. 5 is a block diagram illustrating an example computing device, in accordance with one or more aspects of the present disclosure. FIG. 5 illustrates only one example of a computing device, which in FIG. 5 is computing device 134 of FIG. 1. Many other examples of computing device 134 may be used in other instances and may include a subset of the components included in example computing device 134 or may include additional components not shown example computing device 134 in FIG. 5. Computing device 134 may be a remote computing device (e.g., a server computing device) from computing device 116 in FIG. 1.

In some examples, computing device 134 may be a server, tablet computing device, smartphone, wrist- or head-worn computing device, laptop, desktop computing device, or any other computing device that may run a set, subset, or superset of functionality included in application 228. In some examples, computing device 134 may correspond to computing device 134 depicted in FIG. 1. In other examples, computing device 134 may also be part of a system or device that produces pathway articles.

As shown in the example of FIG. 5, computing device 134 may be logically divided into user space 502, kernel space 504, and hardware 506. Hardware 506 may include one or more hardware components that provide an operating environment for components executing in user space 502 and kernel space 504. User space 502 and kernel space 504 may represent different sections or segmentations of memory, where kernel space 504 provides higher privileges to processes and threads than user space 502. For instance, kernel space 504 may include operating system 520, which operates with higher privileges than components executing in user space 502. In some examples, any components, functions, operations, and/or data may be included or executed in kernel space 504 and/or implemented as hardware components in hardware 506.

As shown in FIG. 5, hardware 506 includes one or more processors 508, input components 510, storage devices 512, communication units 514, and output components 516. Processors 508, input components 510, storage devices 512, communication units 514, and output components 516 may each be interconnected by one or more communication channels 518. Communication channels 518 may interconnect each of the components 508, 510, 512, 514, and 516 for inter-component communications (physically, communicatively, and/or operatively). In some examples, communication channels 518 may include a hardware bus, a network connection, one or more inter-process communication data structures, or any other components for communicating data between hardware and/or software.

One or more processors 508 may implement functionality and/or execute instructions within computing device 134. For example, processors 508 on computing device 134 may receive and execute instructions stored by storage devices 512 that provide the functionality of components included in kernel space 504 and user space 502. These instructions executed by processors 508 may cause computing device 134 to store and/or modify information, within storage devices 512 during program execution. Processors 508 may execute instructions of components in kernel space 504 and user space 502 to perform one or more operations in accordance with techniques of this disclosure. That is, components included in user space 502 and kernel space 504 may be operable by processors 508 to perform various functions described herein.

One or more input components 510 of computing device 134 may receive input. Examples of input are tactile, audio, kinetic, and optical input, to name only a few examples. Input components 510 of computing device 134, in one example, include a mouse, keyboard, voice responsive system, video camera, buttons, control pad, microphone or any other type of device for detecting input from a human or machine. In some examples, input component 510 may be a presence-sensitive input component, which may include a presence-sensitive screen, touch-sensitive screen, etc.

One or more communication units 514 of computing device 134 may communicate with external devices by transmitting and/or receiving data. For example, computing device 134 may use communication units 514 to transmit and/or receive radio signals on a radio network such as a cellular radio network. In some examples, communication units 514 may transmit and/or receive satellite signals on a satellite network such as a Global Positioning System (GPS) network. Examples of communication units 514 include a network interface card (e.g. such as an Ethernet card), an optical transceiver, a radio frequency transceiver, a GPS receiver, or any other type of device that can send and/or receive information. Other examples of communication units 514 may include Bluetooth®, GPS, 3G, 4G, and Wi-Fi® radios found in mobile devices as well as Universal Serial Bus (USB) controllers and the like.

One or more output components 516 of computing device 134 may generate output. Examples of output are tactile, audio, and video output. Output components 516 of computing device 134, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 516 may be integrated with computing device 134 in some examples.

In other examples, output components 516 may be physically external to and separate from computing device 134, but may be operably coupled to computing device 134 via wired or wireless communication. An output component may be a built-in component of computing device 134 located within and physically connected to the external packaging of computing device 134 (e.g., a screen on a mobile phone). In another example, a presence-sensitive display may be an external component of computing device 134 located outside and physically separated from the packaging of computing device 134 (e.g., a monitor, a projector, etc. that shares a wired and/or wireless data path with a tablet computer).

One or more storage devices 512 within computing device 134 may store information for processing during operation of computing device 134. In some examples, storage device 512 is a temporary memory, meaning that a primary purpose of storage device 512 is not long-term storage. Storage devices 512 on computing device 134 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 512, in some examples, also include one or more computer-readable storage media. Storage devices 512 may be configured to store larger amounts of information than volatile memory. Storage devices 512 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 512 may store program instructions and/or data associated with components included in user space 502 and/or kernel space 504.

As shown in FIG. 5, application 528 executes in userspace 502 of computing device 134. Application 528 may be logically divided into presentation layer 522, application layer 524, and data layer 526. Application 528 may include, but is not limited to the various components and data illustrated in presentation layer 522, application layer 524, and data layer 526.

Data layer 526 may include one or more datastores. A datastore may store data in structure or unstructured form. Example datastores may be any one or more of a relational database management system, online analytical processing database, table, or any other suitable structure for storing data.

Computing device 134 may include or be communicatively coupled to construction component 517, in the example where computing device 134 is a part of a system or device that produces pathway articles, such as described in relation to computing device 134 in FIG. 1. In other examples, construction component 517 may be included in a remote computing device that is separate from computing device 134, and the remote computing device may or may not be communicatively coupled to computing device 134. Construction component 517 may send construction data to construction device, such as construction device 138 that causes construction device 138 to print an article message in accordance with a printer specification and data indicating one or more characteristics of a vehicle pathway.

As described above in relation to FIG. 1, construction component 517, may receive data that indicates an STE from selection component 552. Selection component 552 is further description in FIG. 8. Construction component 517, in conjunction with other components of computing device 134, may determine an article message that indicates the STE. As described above in relation to FIG. 1, the article message may include the STE, a graphical symbol, a fiducial marker and one or more additional elements that may contain the one or more characteristics of the vehicle roadway. The article message may include both machine-readable and human readable elements. Construction component 517 may provide construction data to construction device 138 to form the article message on a pathway article. In some examples, computing device 134 may communicate with construction device 138 to initially manufacture or otherwise create the pathway article with an article message that includes an STE. Construction device 138 may be used in conjunction with computing device 134, which may control the operation of construction device 138, as in the example of computing device 134 of FIG. 1.

In some examples, construction device 138 may be any device that prints, disposes, or otherwise forms an article message on a pathway article. Examples of construction device 138 include but are not limited to a needle die, gravure printer, screen printer, thermal mass transfer printer, laser printer/engraver, laminator, flexographic printer, an ink-jet printer, an infrared-ink printer. In some examples, enhanced sign 108 may be the retroreflective sheeting constructed by construction device 138, and a separate construction process or device, which is operated in some cases by a different operators or entities than construction device 138, may apply the article message to the sheeting and/or the sheeting to the base layer (e.g., aluminum plate).

Construction device 138 may be communicatively coupled to computing device 134 by one or more communication links. Computing device 134 may control the operation of construction device 138 or may generate and send construction data to construction device 138. Computing device 134 may include one or more printing specifications. A printing specification may comprise data that defines properties (e.g., location, shape, size, pattern, composition or other spatial characteristics) of article message 126 on a pathway article. In some examples, the printing specification may be generated by a human operator or by a machine. In any case, construction component 517 may send data to construction device 138 that causes construction device 138 to print an article message in accordance with the printer specification and the data that indicates at least one characteristic of the vehicle pathway.

The components of article message 126 a pathway article depicted in FIG. 1 may be printed using a flexographic printing process. For instance, enhanced sign 108 may include a base layer (e.g., an aluminum sheet), an adhesive layer disposed on the base layer, a structured surface disposed on the adhesive layer, and an overlay layer disposed on the structured surface such as described in U.S. Publication US2013/0034682, US2013/0114142, US2014/0368902, US2015/0043074, which are hereby expressly incorporated by reference in their entireties. The structured surface may be formed from optical elements, such as full cubes (e.g., hexagonal cubes or preferred geometry (PG) cubes), or truncated cubes, or beads as described in, for example, U.S. Pat. No. 7,422,334, which is hereby expressly incorporated by reference in its entirety.

To create non-visible components at different regions of the pathway article, a barrier material may be disposed at such different regions of the adhesive layer. The barrier material forms a physical “barrier” between the structured surface and the adhesive. By forming a barrier that prevents the adhesive from contacting a portion of the structured surface, a low refractive index area is created that provides for retroflection of light off the pathway article back to a viewer. The low refractive index area enables total internal reflection of light such that the light that is incident on a structured surface adjacent to a low refractive index area is retroreflected. In this embodiment, the non-visible components are formed from portions of the barrier material.

In other embodiments, total internal reflection is enabled by the use of seal films which are attached to the structured surface of the pathway article by means of, for example, embossing. Exemplary seal films are disclosed in U.S. Patent Publication No. 2013/0114143, and U.S. Pat. No. 7,611,251, all of which are hereby expressly incorporated herein by reference in their entirety.

In yet other embodiments, a reflective layer is disposed adjacent to the structured surface of the pathway article, e g enhanced sign 108, in addition to or in lieu of the seal film. Suitable reflective layers include, for example, a metallic coating that can be applied by known techniques such as vapor depositing or chemically depositing a metal such as aluminum, silver, or nickel. A primer layer may be applied to the backside of the cube-corner elements to promote the adherence of the metallic coating.

In some examples construction device 138 may be at a location remote from the installed location of the pathway article. In other examples, construction device 138 may be mobile, such as installed in a truck, van or similar vehicle, along with an associated computing device, such as computing device 134. A mobile construction device may have advantages when local vehicle pathway conditions indicate the need for a temporary or different sign. For example, in the event of a road washout, where there is only one lane remaining, in a construction area where the vehicle pathway changes frequently, or in a warehouse or factory where equipment or storage locations may change. A mobile construction device may receive construction data, as described, and create a pathway article at the location where the article may be needed. In some examples, the vehicle carrying the construction device may include sensors that allow the vehicle to traverse the changed pathway and determine pathway characteristics. In some examples, the substrate containing the article message may be removed from a base layer of the article and replaced with an updated substrate containing a new article message. This may have an advantage in cost savings.

Computing device 134 may receive data that indicates characteristics or attributes of the vehicle pathway from a variety of sources. In some examples, computing device 134 may receive vehicle pathway characteristics from a terrain mapping database, a light detection and ranging (LIDAR) equipped aircraft, drone or similar vehicle. As described in relation to FIG. 1, a sensor equipped vehicle may traverse, measure and determine the characteristics of the vehicle pathway. In other examples, an operator may walk the vehicle pathway with a handheld device. Sensors, such as accelerometers may determine pathway characteristics or attributes and generate data for computing device 134. As described in relation to FIG. 1, computing device 134 may receive a printer specification that defines one or more properties of the pathway article. The printer specification may also include or otherwise specify one or more validation functions and/or validation configurations, as further described in this disclosure. To provide for counterfeit detection, construction component 517 may print security elements and article message in accordance with validation functions and/or validation configurations. A validation function may be any function that takes as input, validation information (e.g., an encoded or literal value(s) of one or more of the article message and/or security elements of a pathway article), and produces a value as output that can be used to verify whether the combination of the article message indicates a pathway article is authentic or counterfeit. Examples of validation functions may include one-way functions, mapping functions, or any other suitable functions. A validation configuration may be any mapping of data or set of rules that represents a valid association between validation information of the one or more security elements and the article message, and which can be used to verify whether the combination of the article message and validation information indicate a pathway article is authentic or counterfeit. As further described in this disclosure, a computing device may determine whether the validation information satisfies one or more rules of a validation configuration that was used to generate the construct the pathway article with the article message and the at least one security element, wherein the one or more rules of the validation configuration define a valid association between the article message and the validation information of the one or more security elements.

The following examples provide other techniques for creating portions of the article message in a pathway article, in which some portions, when captured by an image capture device, may be distinguishable from other content of the pathway article. For instance, a portion of an article message, such as a security element may be created using at least two sets of indicia, wherein the first set is visible in the visible spectrum and substantially invisible or non-interfering when exposed to infrared radiation; and the second set of indicia is invisible in the visible spectrum and visible (or detectable) when exposed to infrared. Patent Publication WO/2015/148426 (Pavelka et al) describes a license plate comprising two sets of information that are visible under different wavelengths. The disclosure of WO/2015/148426 is expressly incorporated herein by reference in its entirety. In yet another example, a security element may be created by changing the optical properties of at least a portion of the underlying substrate. U.S. Pat. No. 7,068,434 (Florczak et al), which is expressly incorporated by reference in its entirety, describes forming a composite image in beaded retroreflective sheet, wherein the composite image appears to be suspended above or below the sheeting (e.g., floating image). U.S. Pat. No. 8,950,877 (Northey et al), which is expressly incorporated by reference in its entirety, describes a prismatic retroreflective sheet including a first portion having a first visual feature and a second portion having a second visual feature different from the first visual feature, wherein the second visual feature forms a security mark. The different visual feature can include at least one of retroreflectance, brightness or whiteness at a given orientation, entrance or observation angle, as well as rotational symmetry. Patent Publication No. 2012/240485 (Orensteen et al), which is expressly incorporated by reference in its entirety, describes creating a security mark in a prismatic retroreflective sheet by irradiating the back side (i.e., the side having prismatic features such as cube corner elements) with a radiation source. U.S. Patent Publication No. 2014/078587 (Orensteen et al), which is expressly incorporated by reference in its entirety, describes a prismatic retroreflective sheet comprising an optically variable mark. The optically variable mark is created during the manufacturing process of the retroreflective sheet, wherein a mold comprising cube corner cavities is provided. The mold is at least partially filled with a radiation curable resin and the radiation curable resin is exposed to a first, patterned irradiation. Each of U.S. Pat. Nos. 7,068,464, 8,950,877, US 2012/240485 and US 2014/078587 are expressly incorporated by reference in its entirety.

In some examples, computing device 134 may include remote service component 556. Remote service component 556 may provide one or more services to remote computing devices, such as computing device 116 included in vehicle 110A. Remote service component 556 may send information stored in remote service data 558 that indicates one or more operations, rules, or other data that is usable by computing device 116 and/or vehicle 110A. For example, operations, rules, or other data may indicate vehicle operations, traffic or pathway conditions or characteristics, objects associated with a pathway, other vehicle or pedestrian information, or any other information usable by computing device 116 and/or vehicle 110A. In some examples, remote service data 558 includes information descriptive of an object that corresponds to the article in association with the structured texture element. For example, service data 558 may indicate an association between the structured texture element and the information descriptive of an object. If a particular structured texture embedding is identified or selected, the associated information descriptive of the object may be retrieved, transmitted or other processed by remote service data 558, and in some examples, in communication with computing device 116. In some examples, UI component 554 may provide one or more user interfaces that enable a user to configure or otherwise operate selection component 552, remote service component 556, article message data 550, and/or remote service data 558.

The examples described in this disclosure may be performed in any of the environments and using any of the articles, systems, and/or computing devices described in the figures and examples described herein. Although various components and operations of FIG. 5 are illustrated as implemented in computing device 134, in other examples, the components and operations may be implemented on different and/or separate computing devices.

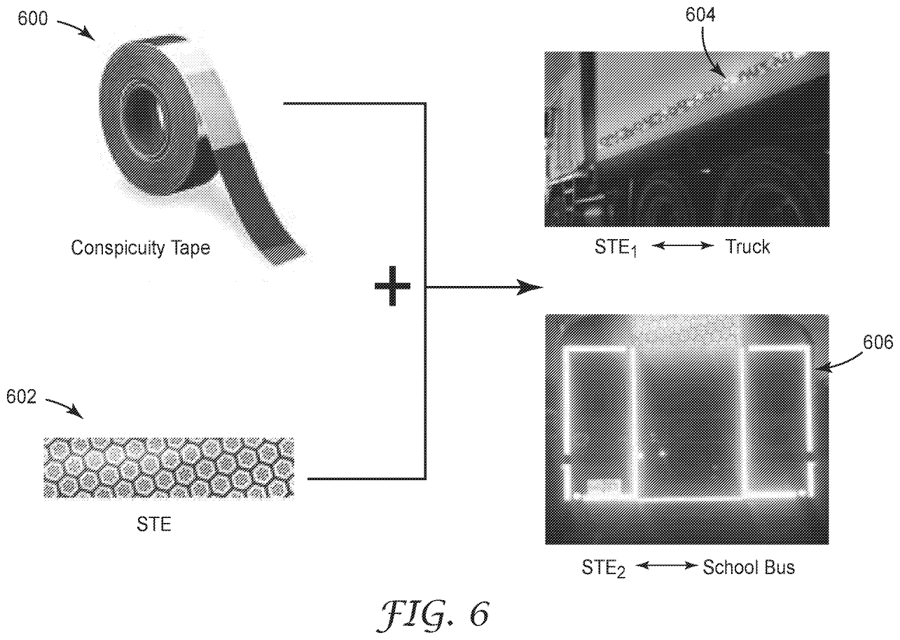

FIG. 6 illustrates structured texture embeddings that may be implemented at retroreflective articles in accordance with techniques of this disclosure. As shown in FIG. 6, conspicuity tape 600 may include structured texture embedding 602. STE 602 may be printed or otherwise embodied on conspicuity tape 600 using one more fabrication techniques described in this disclosure. As shown in FIG. 6, STE₁ 604 may be applied to the trailer of a semi-tractor trailer. STE₂ 606 may be applied to rear side of school bus. In some examples, STE 604 and 606 may indicate or be associated with information that indicates a type of vehicle (e.g., “TRUCK”, “SCHOOL BUS”), a portion or part of a vehicle (e.g., “LEFT SIDE” “REAR SIDE”) or any other suitable information. In other examples of STEs in pavement markings, such STEs may indicate or be associated with position of the pavement marking, lane identifier of the pavement marking, number of lanes, direction of traffic, type of lane, or any other property or characteristic of the pathway or objects associated with the pathway.

As described in this disclosure, structured texture embeddings (STEs) in retroreflective articles may be used for machine recognition and processing. In some examples, the machine recognition and process may identify different vehicle types. The systems, articles, and techniques of this disclosure may couple the design of STEs and their recognition in retroreflective materials. The systems, articles, and techniques of this disclosure may enrich information, via the implanted STEs, that retroreflective articles convey towards improving their machine readability. FIG. 6 presents an example of the amalgamation of STEs 604 and 606 with retroreflective conspicuity tape 600 for two vehicle types which are commonly required to exhibit retroreflective materials for safety purposes. Although examples may be described with respect to conspicuity tape, in other examples, the systems, articles, and techniques may be directed to pavement markings, roadway signs, personally worn articles, buildings, vehicles, or any other object having a surface which may include STEs.

Enhancing conspicuity tape with STEs can lead to improved machine readability. Consequently, this can aid autonomous vehicles to identify the type of the vehicle ahead of them (e.g. distinguishing trailers from trucks) and adopt this information in their control strategies with the goal of increasing safety. STEs can be also integrated with other products including pavement markings as well as aid with counterfeit product identification. Such solutions may solve problems existing in trends in the automotive industry.

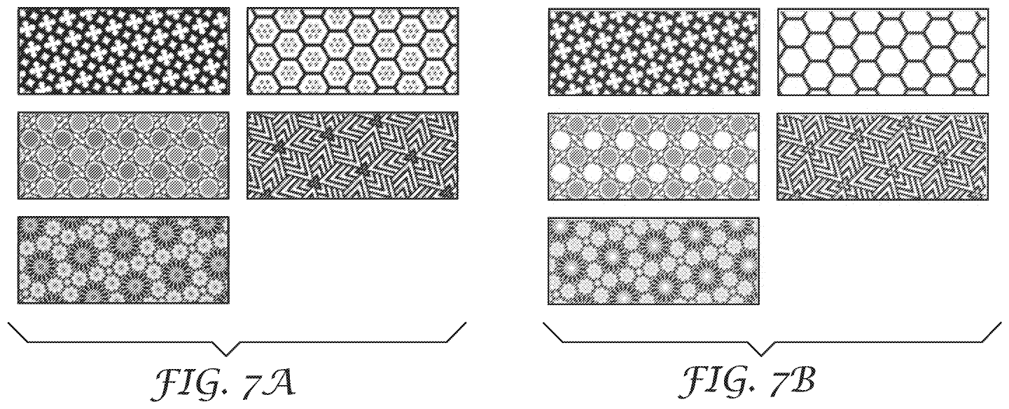

STEs may be stored in and selected from one or more datastores that include one or more STE. These STEs may be designed and printed in order to emit the STE both in the visible and IR spectrum. FIGS. 7A and 7B, illustrate five candidate patterns for this task in the visible spectrum as shown in FIG. 7A as well as the IR spectrum in FIG. 7B. The decision on the geometry of this first group of STEs in FIGS. 7A-7B may be based on two considerations relevant to the ease of printing (repetitive patterns may be a more effective solution) and whether the patterns exhibit radically different geometric characteristics which can be more easily imprinted in their mathematical descriptions.

In FIGS. 7A and 7B, SIFT features may be selected and processed to assess the dissimilarity among the candidate STEs and/or a set of one or more natural environment scenes. Briefly, SIFT features may be features that are used to characterize local patterns in images. The attractiveness of SIFT features may stem from their scale invariance. In that way, SIFT keypoints are identified in an image at different scales and a compact description maybe calculated in the form of a 128-element vector for every keypoint. One or more descriptors may be computed in the form of histograms of gradient orientations that characterize the vicinity of the keypoint.

In FIG. 8, to illustrate that selected STEs exhibit different geometric characteristics from each other and/or a set of one or more natural environment scenes in which the STEs may be used, retroreflective articles with STEs may be printed (physically or in a simulation) and machine read (physically or in a simulation) to extract keypoints from reference STEs, and in other operations identify them in streaming video, such as shown in FIG. 8, which identifies that STE₃ is present in on the retroreflective article. In FIG. 8, STEs may be pre-processed offline and a set of reference SIFT features is collected, associated with the distinct geometric characteristics of each STE. Once reference descriptors are computed for all targeted STEs, a computing device can test the recognition ability on streaming video.

FIG. 8 illustrates techniques for computationally generating STEs for differentiation, in accordance with this disclosure. In the example of FIG. 8, computing device 134 may generate one or more one or more STEs where the visual appearance of a structured texture elements is computationally generated for differentiation from a visual appearance of a natural environment scene for the article of conspicuity tape and/or one or more other STEs. Selection component 800 may be implemented as hardware, software, and/or a combination of hardware and software in one or more devices, such as computing device 134. Selection component 800 may include generator component 802 and simulator component 804, each of which may be implemented as hardware, software, and/or a combination of hardware and software in one or more devices, such as computing device 134.

In some examples, generator component 802 may generate or select one or more STEs. For example, an STE and/or natural environment scene may have a visual appearance. A visual appearance may be one or more visual features, characteristics or properties. Examples of visual features, characteristics, or properties may include but are not limited to: shapes; colors; curves; points; segments; patterns; luminance; visibility in particular light wavelength spectrums; sizes of any features, characteristics, or properties; or widths or lengths of any features, characteristics, or properties. An STE may be identified by a machine vision system based on its visual appearance. An STE may be differentiated from a another, different STE by a machine vision system based on visual appearances of one or more of the STEs. An STE may be differentiated from a natural environment scene by a machine vision system based on visual appearances of the STE and/or the natural environment scene.

Generator component 802 may computationally generate or select one or more of STEs 806A-806C. For instance, generator component 802 may generate or select one or more features, characteristics, or properties in a repeating pattern or non-repeating arrangement. Generator component 802, may apply one or more feature recognition techniques to extract keypoints 808A-808C that correspond respectively to STEs 806A-806C. Keypoints may represent, correspond to, or identify visual features that are present in a particular STE. As such keypoints 808A may be processed by one or more feature recognition techniques to determine that an image includes STE 806A. As another example, keypoints 808B may be processed by one or more feature recognition techniques to determine that an image includes STE 806B. In some examples, one or more of STEs 806A-806C and/or visual features that are present in the STEs may be selected from a pre-existing data set of STEs and/or visual features, rather than generated by generator component 802.

Simulator component 804 may simulate feature recognitions techniques on one or more STES and/or natural scenes that include one or more STEs. For instance, input video frames 810 may be a set of images that include STE 806A. Simulator component 804 may process one or more of the images using feature recognition techniques to determine that an image includes a set of keypoints 812. Keypoints 812 may include a sub-set of keypoints that correspond to STE 808A. Keypoints 812 may include other sub-sets of keypoints that correspond to STEs 808B and 808C, respectively. Inference component 814 may apply one or more techniques to determine, based on keypoints 812, which STE(s) are present (if any) in a image or set of images. Such techniques may include determining which sub-set of keypoints has the highest number of keypoints that correspond to or match keypoints for a particular STE, determining which sub-set has the highest probability of keypoints that correspond to or match keypoints for a particular STE, or any other suitable selection technique to determine that a particular STE corresponds to the extracted keypoints 812. Inference component 814 may, using the selection technique, output an identifier or other data that indicates the STE corresponding to one or more of keypoints 812.

To computationally generate STEs for differentiation from a visual appearance of a natural environment scene and/or other STEs, generator component 802 may generate or select one or more STEs. Simulator component 804 may apply feature recognition techniques, such as keypoint extraction or other suitable techniques, to the images of input video frames 810. Based on the confidence level or amount of keypoints that match a particular STE, simulator component 804 may associate a score or other indicator of the degree of differentiation between the particular STE and one or more (a) natural scenes that include the particular STE, and/or (b) one or more other STEs. In this way, simulator component 804 may receive multiple different STEs and simulate which STEs will be more differentiable from natural scenes and/or other STEs. In some examples, a threshold for required differentiation may be configured by a user and/or computing device. A particular STE that satisfies the threshold (e.g., particular STE is differentiated from natural scenes and/or other STEs greater than or equal to the threshold) may selected by simulator component 804. In some examples, differentiation between the particular STE and (a) natural scenes that include the particular STE, and/or (b) one or more other STEs, may be based on a degree of visual similarity or visual difference between the particular STE and (a) natural scenes that include the particular STE, and/or (b) one or more other STEs. The degree of visual similarity may be based on the difference in pixel values, blocks within an image, or other suitable image comparison techniques. In some examples, input video frames 810 may include images of one or more actual, physical STEs in one or more actual, physical natural scenes. In other examples, input video frames 810 may include images of one or more simulated STEs in one or more simulated natural scenes. In still other examples, a combination of STEs and natural scenes that are simulated and/or actual, physical may be used by simulator component 804.

In some examples, inference component 814 may provide feedback data to one or more of generator component 802 and/or simulator component 804. The feedback data may include but is not limited to: data that indicates whether a particular STE that satisfies differentiation threshold, a degree of differentiation of the particular STE, an identifier of the particular STE, an identifier of a natural scene, an identifier of another STE, or any other information usable by generator component 802 and/or simulator component 804 to generate one or more STEs. Generator component 802 may use feedback data from inference component 814 to change the visual appearance of one or more new STE to simulate that are generated such that the one or more new STEs have greater differentiability from other previously simulated STEs. Generator component 802 may use the feedback data to alter the visual appearances of the one or more new STEs, such that the visual differentiation increases between the new STEs and the previously simulated STE. In this way, STEs can be generated that have greater amounts or degrees of visual differentiation from natural scenes and/or other STEs.

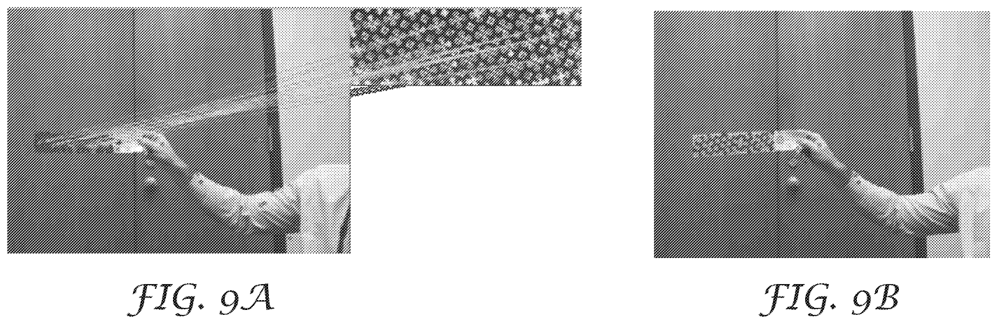

FIGS. 9A-9B, present a sample output of validation performed by a computing device, such as computing device 116 and/or computing device(s) 134. A targeted STE can be seen in FIG. 9A where lines represent the matches of keypoints (depicted as blue circles) between the STE in the video frame and the target STE. In contrast, when displaying an alternate STE in FIG. 9B rather than the target STE no correspondences are identified. It should be noted that although some techniques may be based on SIFT feature matching, techniques of this disclosure can accommodate for different methodologies such as FV-CNN, which is described in Cimpoi, M., Maji, S., & Vedaldi, A. (2015). Deep filter banks for texture recognition and segmentation. In Proceedings of the IEEE Conference on Computer Vision and Pattern Recognition (pp. 3828-3836), the entire content of each of which is hereby incorporated by reference in its entirety. STEs can be embedded in retroreflective materials in the context of vehicle type recognition, both in day and night lighting conditions. In addition, the proposed scheme may not only distinguishes vehicles of different types but also aids in their recognition from their background signifying their presence.

Techniques of this disclosure may also implement or utilize systems, articles, and techniques as described in PCT/US2017/053632 filed Sep. 27, 2017 and PCT/US2018/018642 filed Feb. 18, 2018, the entire content of each of which are hereby incorporated by reference in their entirety. In some examples, a system may include a light capture device, and a retroreflective article comprising a structured texture element (STE). In some examples, the STE corresponds to a particular identifier, the particular identifier being based on a unique arrangement of visual features in the STE that are identifiable through a single retroreflective property. In some examples, a computing device is communicatively coupled to the light capture device, wherein the computing device is configured to receive, from the light capture device, retroreflected light that indicates at least the single retroreflective property. The computing device may determine, based at least in part on the single retroreflective property, the particular identifier that corresponds to the unique arrangement of features in the STE. The computing device may perform at least one operation based at least in part on the particular identifier. Various operations are described in this disclosure.

Pavement markers (e.g., paints, tapes, and individually mounted articles) may guide and direct autonomous or computer-assisted vehicles, motorists and pedestrians traveling along roadways and paths. Pavement markers may be used on, for example, roads, highways, parking lots, and recreational trails, to form stripes, bars and markings for the delineation of lanes, crosswalks, parking spaces, symbols, legends, and the like.

Pavement marker variations on the roadway may provide information on the traffic patterns and the surrounding infrastructure. These variations may include spacing between pavement markers, placement of pavement markers relative to infrastructure, size of the pavement marker, and color of the pavement marker. As an example, spacing and size of the pavement markers on an interstate road may demark an exit only lane. It may be beneficial for connected and automated vehicles if pavement markers could provide additional information about traffic patterns and the surrounding infrastructure.

In one example, systems, articles, and techniques of this disclosure relate to a pavement marker with structured texture embeddings where the texture is repeating on at least a portion of the pavement marker and where the texture is associated with at least one traffic pattern or infrastructure feature. A pavement marker with structured texture embeddings installed in a parking lot may have a texture that associates with parking spaces.

Conspicuity tape may increase visibility of specialized vehicles on transportation infrastructure to help the safe navigation of vehicles, especially in dark and adverse navigation conditions. Conspicuity tape may be used on, for example, emergency vehicles, school busses, trucks, trailers, rail cars, commercial vehicles to outline the shape of the vehicle, the orientation of the vehicle, unique vehicle features, or the footprint of the vehicle. Additional information about specialized vehicles on transportation infrastructure from conspicuity tape placed on those specialized vehicles may help further enable safe vehicle navigation.

In some examples, systems, articles, and techniques of this disclosure relate to conspicuity tape with one or more optically active layers and structured texture embeddings where the texture is at least periodically repeating along the length of the conspicuity tape. The optically active layer may include prismatic retroreflective sheeting or beaded retroreflective sheeting. The texture may be created by pattern variations, including variations in retroreflective and non-retroreflective properties, including intensity, wavelength, and phase properties.

In some examples, conspicuity tapes with structured texture embeddings have textures associated with specific specialized vehicles where a camera system can read the conspicuity tape texture and associate the texture with a class of vehicle information that may be used to aid in safe vehicle navigation. In one example, a vehicle approaches a specialized vehicle with structure-texture embedded conspicuity tape. The vehicle reads the texture of the conspicuity tape and determines it is texture type A. Based on a look-up table, texture A is associated with a standard human operated truck and trailer with a range of expected vehicle lengths. In another example, a vehicle approaches a specialized vehicle with structure-texture embedded conspicuity tape. A vehicle may read the texture and determines it is texture type B. Based on a look-up table, texture B is associated with an autonomous truck and trailer that operates in close convoys. The difference in information provided from texture A and texture B may impact how a vehicle navigates around the specialized vehicles.

FIG. 10 is a block diagram illustrating different patterns that may be embodied on an article with an STE, in accordance with this disclosure. FIG. 10 illustrates pathway article 300 as previously described in FIG. 3. Retroreflective sheet 304 is further identified for purposes of illustration in FIG. 10, and other layers may also be included pathway article 300. For example purposes, pathway article 300 is a portion of conspicuity tape, although pathway article 300 may be any pathway article in other examples.

In some examples, pathway article 300 may include a set of one or more patterns. In some examples, each of the one or more patterns may co-exist and/or be coextensive on retroreflective sheeting 304. In some examples, one or more patterns may be visible in a first light spectrum while one or more other patterns may be visible in second light spectrum that is different than the first light spectrum. Each of the patterns may be of different or the same color and/or luminance. Retroreflective article 304 need not include all of the embodied patterns illustrated in FIG. 10, and in some examples may include a subset of all the embodied patterns illustrated in FIG. 10. In some examples, retroreflective article 304 may include a superset of all embodied patterns illustrated in FIG. 10.

For example, pathway article 300 may include first embodied pattern 1002. Embodied pattern 1002 may be created by sealing certain portions of retroreflective sheeting 304. FIG. 10 illustrates a sealing seem 1004 that forms a perimeter of sealed area 1006. In some examples, sealed area 1006 includes a sealed space, which may contain air (effectively an air gap or air pocket) or other material. As shown in FIG. 10, embodied pattern 1002 may include a set of sealed areas created by sealing seems that recur in a repeating pattern. For purposes of illustration, embodied pattern 1002 is only shown on a portion of retroreflective sheeting 304, although in other examples embodied pattern 1002 may cover the entire area of retroreflective sheeting 304 or certain defined regions of retroreflective sheeting 304. In some examples, perimeters represented by sealing seems in FIG. 10 may be printed rather physically created as seams that create sealed spaces. In other words, embodied pattern 1002 may be printed on retroreflective sheeting 304 without creating physical seams that enclose sealed areas filled with air or other material.

As shown in FIG. 10, retroreflective sheeting 304 may include a second embodied pattern 108. Embodied pattern 108 may include pattern regions 1010A-1010C. In FIG. 10, pattern regions 1010A, 1010C may be a first color (e.g., red) or first design, while pattern region 1010B may be a second color (e.g., white) or second design. The first color and/or design may be different than the second color and/or design as shown in FIG. 10. In other examples, embodied pattern 108 may be a solid color or solid design. For purposes of illustration, embodied pattern 1002 is shown to cover the entire area of retroreflective sheeting 304, although in other examples embodied pattern 1002 may cover certain defined regions of retroreflective sheeting 304.

Retroreflective sheeting 304 may include a third embodied pattern 1012. Embodied pattern 1012 may be a structured texture embedding as described in accordance with techniques of this disclosure. Embodied pattern 1012 may be co-exist and/or be coextensive on retroreflective sheeting 304 with one or more of embodied patterns 1008 and/or 1002. For purposes of illustration, embodied pattern 1012 is only shown on a portion of retroreflective sheeting 304 within pattern region 1010B, although in other examples embodied pattern 1012 may cover the entire area of retroreflective sheeting 304 or certain defined regions of retroreflective sheeting 304.

Although the examples of FIG. 10 have been described such that the patterns 1002, 1008, and/or 1012 are printed, formed, or otherwise embodied on retroreflective sheeting 304, in some examples, one or more of the patterns may be printed, formed, or otherwise embodied on other or different layers of pathway article 300.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples of the disclosure have been described. These and other examples are within the scope of the following claims.

1. A system comprising:
a light capture device;
a computing device communicatively coupled to the light capture device, wherein the computing device is configured to:
receive, from the light capture device, light that indicates a structured texture element (STE) embodied on an article of conspicuity tape, wherein a visual appearance of the structured texture element is computationally generated for differentiation from a visual appearance of a natural environment scene for the article of conspicuity tape;
determine information that corresponds to an arrangement of features in the STE; and
perform at least one operation based at least in part on the information that corresponds to the arrangement of features in the STE.

2. The system of claim 1, wherein the information indicates a vehicle in a vehicle platoon.

3. The system of claim 1, wherein to perform at least one operation that is based at least in part on the information that corresponds to the arrangement of features in the STE the computing device is configured to select a level of autonomous driving for a vehicle that includes the computing device.

4. The system of claim 1, wherein the article comprises at least one retroreflective property.

5. The system of claim 1, wherein the retroreflected light is light in at least one of the infrared spectrum, the ultraviolet spectrum, or the visible light spectrum.

6. The system of claim 1, wherein the computing device is configured to: identify a set of one or more detection elements from an image generated based on the retroreflected light; and
determine that the one or more detection elements correspond to the information.

7. The system of claim 1, wherein the one or more detection elements comprise one or more SIFT features.

8. The system of claim 1, wherein the structured texture element is a first structured texture element, wherein the first structured texture element is computationally generated for differentiation from a second structured texture element.

9. The system of claim 1, wherein the first structured texture element is computationally generated for differentiation from the second structured texture element to satisfy a threshold amount of differentiation.

10. The system of claim 1, wherein the threshold amount of differentiation is a maximum amount of differentiation.

11. The system of claim 1, wherein to perform at least one operation that is based at least in part on the information that corresponds to the arrangement of features in the STE the computing device is configured to change an operation of a vehicle that is associated with the light capture device.

12. The system of claim 1, wherein the operation of the vehicle comprises at least one of: generating an visual, audible, or haptic output; performing a braking function; performing an acceleration function; performing a turning function; sending or receiving a vehicle-to-vehicle, vehicle-to-infrastructure, or vehicle-to-pedestrian communication.

13. The system of claim 1, wherein to determine information that corresponds to an arrangement of features in the STE, the computing device is configured to:
apply image data that represents the visual appearance of the structured texture element to a model; and
generate, based at least in part on application of the image data to the model, information that indicates the structured texture element.

14. The system of claim 1, wherein model has been trained based at least in part on one or more training images comprising the structured texture element.

15. The system of claim 1, wherein model comprises a model configured based on at least one of a supervised, semi-supervised, or unsupervised technique.

16. A computing device configured to perform any of the operations of claim 1.

17. An article of conspicuity tape comprising:
a retroreflective substrate; and
a structured texture element (STE) embodied on the retroreflective substrate, wherein a visual appearance of the structured texture element is computationally generated for differentiation from a visual appearance of a natural environment scene for the article of conspicuity tape.

18. The article of conspicuity tape of claim 17, wherein the structured texture element is a first structured texture element, wherein the first structured texture element is computationally generated for differentiation from a second structured texture element.

19. The article of conspicuity tape of claim 17, wherein the first structured texture element and the second structured texture element are included in a set of structured texture elements, and each respective structured texture element included in the set of structured texture elements is computationally generated for differentiation from each other structured texture element in the set of structured texture elements.

20. The article of conspicuity tape of claim 17, wherein each respective structured texture element included in the set of structured texture elements is computationally generated for differentiation from the natural environment scene for the article of conspicuity tape and each other structured texture element in the set of structured texture elements.

21. The article of conspicuity tape of claim 17, wherein the first structured texture element is computationally generated for differentiation from a second structured texture element to satisfy a threshold amount of differentiation.

22. The article of conspicuity tape of claim 17, wherein the threshold amount of differentiation is a maximum amount of differentiation.

23. The article of conspicuity tape of claim 17, wherein the maximum amount of differentiation is a largest amount of dissimilarity between the visual appearance of the first structured texture element and the visual appearance of the second structured texture element.

24. The article of conspicuity tape of claim 17, wherein the wherein the first structured texture element is computationally generated to produce a first set of detection elements from a first image and the second structured texture element is computationally generated to produce a second set of detection elements from a second image, and wherein the first and second structured texture elements are computationally generated to differentiate the first set of detection elements from the second set of detection elements.

25. The article of conspicuity tape of claim 17, wherein the first set of detection elements is computationally generated for differentiation from the second set of detection elements to satisfy a threshold amount of differentiation.

26. The article of conspicuity tape of claim 17, wherein the threshold amount of differentiation is a maximum amount of differentiation.

27. The article of conspicuity tape of claim 17, wherein the structured texture element is a first pattern, and wherein the article of conspicuity tape comprises a second pattern that is a seal pattern, wherein the seal pattern defines one or more sealed areas of the article of conspicuity tape.

28. The article of conspicuity tape of claim 17, wherein the structured texture element is a first pattern, and wherein the article of conspicuity tape comprises a second pattern that is a printed pattern of one or more inks on retroreflective substrate that are different from the first pattern.

29. The article of conspicuity tape of claim 17, wherein the printed pattern of one or more inks is a solid pattern.

30. The article of conspicuity tape of claim 17, wherein the structured texture element is visible in a spectral range of approximately 350 nm to 750 nm.

31. The article of conspicuity tape of claim 17, wherein the structured texture element is visible in at least one spectral range that is outside approximately 350 nm to 750 nm.

32. The article of conspicuity tape of claim 17, wherein the structured texture element is visible within a spectral range of approximately 700 nm to 1100 nm.

33. The article of conspicuity tape of claim 17, wherein the structured texture element is visible within a spectral range of greater than 1100 nm.

34. The article of conspicuity tape of claim 17, wherein the structured texture element is configurable with information descriptive of an object that corresponds to the article of conspicuity tape.

35. The article of conspicuity tape of claim 17, wherein the information descriptive of the object indicates an object in a vehicle platoon.

36. The article of conspicuity tape of claim 17, wherein the information descriptive of the object indicates an autonomous vehicle.

37. The article of conspicuity tape of claim 17, wherein the information descriptive of the object indicates information configured for an autonomous vehicle.

38. The article of conspicuity tape of claim 17, wherein the information descriptive of the object indicates at least one of a size or type of the object.

39. The article of conspicuity tape of claim 17, wherein the object is at least one of a vehicle or a second object associated with the vehicle.

40. The article of conspicuity tape of claim 17, wherein the information descriptive of the object comprises an identifier associated with the object.

41. The article of conspicuity tape of claim 17, wherein the article of conspicuity tape is attached to the object that corresponds to the article of conspicuity tape.
